(19) United States
(12) Patent Application Publication
(10) Pub. No.: US 2017/0161773 A1
(43) Pub. Date: Jun. 8, 2017

(54) Methods and Systems for Targeted Advertising Using Machine Learning Techniques

(71) Applicant: Rovi Guides, Inc., Santa Clara, CA (US)

(72) Inventors: Xiaoxi Xu, Chestnut Hill, MA (US); Steve Bennett, Somerville, MA (US); Walter R. Klappert, Los Angeles, CA (US)

(21) Appl. No.: 14/958,918

(22) Filed: Dec. 3, 2015

(51) Int. Cl. G06Q 30/02; G06N 3/08; G06F 17/30; G06N 7/00

(52) U.S. Cl. CPC G06Q 30/0243; G06N 7/005; G06N 3/08; G06F 17/30477

(57) ABSTRACT

Methods and systems have been provided for matching advertising requests (e.g., for advertisements in an advertising campaign) to advertising events (e.g., during display of a media asset or within a media guidance application) based on predicted viewership information determined using machine learning techniques. Performance of an artificial neural network (ANN) based approach and a support vector machine (SVM) based approach have been described, along with a hybrid approach that combines information from the ANN and SVM approaches. These techniques described with the ANN and SVM are equally applicable to other machine learning techniques.

### BACKGROUND

In conventional systems, audience information for targeted advertising on a platform, such as broadcast media, is predicted based on computation of averages of historical viewership information. Such simple approaches fail to utilize or extract underlying levels within the historical viewership information. Additionally, such simple approaches do not vary the type of predictive analysis to adapt to various characteristics of the historical viewership information.

### SUMMARY

Accordingly, methods and systems are disclosed herein for predicting viewership information for targeted advertising by employing machine learning techniques. For example, artificial neural network (ANN) and support vector machine (SVM) techniques may be employed. Hybrid approaches are also disclosed, whereby results from ANN and/or SVM techniques may be combined to generate a prediction of viewership information at a specified future point in time.

For example, a system may store a queue of advertising events (e.g., interstitial advertising slots during scheduled broadcasting times, or scheduled banner advertisements for display in a media guidance application, etc.). The advertising events may be stored in the queue and ordered according to a scheduled broadcast or display time. For each advertising event in the queue, the system may compute predicted viewership information (e.g., demographic information about viewers of an advertising event at the scheduled time), using a first model configured for long-term predictions (e.g., a support vector machine based model), and using a second model configured for short-term predictions (e.g., an artificial neural network machine based model).

The system may determine a difference between a scheduled time of the retrieved advertising event and a current time (e.g., if the advertising event is scheduled for four weeks from a current time the difference would be four weeks). The system may then compare the difference to a first threshold in order to select among the predicted viewership information (e.g., the long-term prediction from the model configured for long-term or the short-term prediction from the model configured for short-term). The short-term model may be more accurate for short-term predictions while the long-term model may more accurate for long-term predictions.

Based on the comparison, the system may select the long-term prediction if the difference between the scheduled time and current time is greater than the first threshold, or may select the short-term prediction if the difference is less than or equal to the first threshold. The system may store the selected prediction of viewership information and update the advertising event in the queue to include the estimated viewership information.

The system may subsequently match advertising requests from advertising campaigns to one or more advertising events. For example, a car company may initiate an advertising campaign to market cars to a target set of viewers (e.g., adults aged 18-35), a first movie company may initiate an advertising campaign to market an animated movie to a target set of viewers (e.g., children aged 5-10), and a second movie company may initiate an advertising campaign to market a movie (e.g., a puppet movie) to the same target set of viewers as the first movie company (e.g., children aged 5-10). The system may determine that advertising events that take place in the morning have viewership that includes viewers aged 5-10, and may determine that advertising events that take place in the evening have viewers aged 18-35.

The system may retrieve an advertising event (e.g., an interstitial advertisement scheduled for 8:30 AM in the morning) from an advertising event queue, where viewership information has been predicted using at least one of a first model configured for long-term predictions, a second model configured for short-term predictions, or a hybrid model that combines the long-term predictions and short-term predictions. The system may search a database of advertising requests (e.g., including advertising requests of the car company and movie company) for advertising requests that match the predicted viewership information of the retrieved advertising event.

The system may determine that multiple search results match the predicted viewership information (e.g., viewers aged 5-10) of the retrieved advertising event. For example, the system may determine that a first advertising request (e.g., for a first advertisement for the animated movie from the first movie company) and that a second advertising request (e.g., for a second advertisement for the puppet movie from the second movie company) match to the predicted viewership information for the retrieved advertising event. The system may use other information to select among the multiple advertising requests to match to the advertising event. For example, the system may use information such as which advertising campaign of the first movie company and the second movie company has a more imminent completion date. If the second movie company has a more imminent completion date for its campaign than the first movie company (e.g., because its puppet movie will be released weeks before the animated movie of the first movie company), the system may match the second advertising request for the second company to the retrieved advertising event.

The system may link the selected second advertising request (e.g., for the puppet movie) to the retrieved advertising event by updating an entry for the second advertising request in a database to include a unique identifier for the retrieved advertising event, and vice versa, link the advertising event to the advertising request by updating an entry for the advertising event in the advertising event queue to include a unique identifier for the advertising request.

The system may iterate between determining predicted viewership information for advertising events, and matching advertising requests to advertising events. For example, as time progresses and a specified time of an advertising event crosses a threshold, predicted viewership information that had previously been computed using a long-term prediction model may be updated with predicted viewership information computed using a short-term prediction model. After updating the predicted viewership information, a matching process may be executed to update a match of an advertising request to the advertising event based on the updated predicted viewership information. For example, if the predicted viewership information for the morning advertisement has been updated (e.g., to correspond to a demographic of viewers aged 18-35), another advertising request (e.g., for a car commercial, by the first company, targeted to a demographic of viewers aged 18-35) may be matched instead of the previously matched advertisement (e.g., for the puppet movie targeted towards a demographic of viewers aged 5-10 years).

In some aspects, the control circuitry of the system may retrieve an advertising event from a queue of advertising events (e.g., that is stored on a storage device at a server, or a user equipment). The system may compute first predicted viewership information for the retrieved advertising event using a first model configured for predicting long-term viewership information (e.g., a support vector machine based model configured to predict viewership information that is beyond a four week window from a current time) based on historical viewership information (e.g., based on eight or more weeks of historical viewership information for similar prior time slots).

The control circuitry may compute second predicted viewership information for the retrieved advertising event using a second model configured for predicting short-term viewership information (e.g., an artificial neural network based model configured to predict viewership information that is less than or equal to a four week window from a current time) based on historical viewership information (e.g., based on eight or more weeks of historical viewership information for similar prior time slots).

The control circuitry may determine a difference between a scheduled time of the retrieved advertising event and a current time. (e.g., nine weeks from a current time). The control circuitry may compare the difference to a first threshold (e.g., four weeks). In response to determining that the difference (e.g., nine weeks) is greater than the first threshold (e.g., four weeks) based on the comparing, the control circuitry may select the first predicted viewership information (e.g., the predicted viewership information based on the support vector machine based model configured for long-term predictions) as estimated viewership information.

In response to determining that the difference (e.g., if the difference were two weeks), is less than or equal to the first threshold (e.g., four weeks) based on the comparing, the control circuitry may select the second predicted viewership information (e.g., the predicted viewership based on the artificial neural network based model configured for short-term predictions) as estimated viewership information.

The control circuitry may store the selected estimated viewership information for the retrieved advertising event in the queue of advertising events. For example, the control circuitry may update predicted viewership information for an advertising event in the advertising event queue to include the selected estimated viewership information.

In some embodiments, the first predicted viewership information and the second predicted viewership information include demographic information (e.g., age range, and whether the viewers watch a program live or in the same day) for a demographic group, and a percentage of a viewers (e.g., 20% of predicted viewers) from an audience corresponding to the demographic group. The long-term viewership information may be predicted at more than four weeks from the current time, and the short-term viewership information may be predicted at less than or equal to four weeks from the current time.

In some embodiments, the historical viewership information may include identifier information about a media asset (e.g., genre of the media asset, actors in the media asset, etc.), demographic information (e.g., age of viewers, gender of viewers, ethnicity, profession, etc.), a day of week that the media asset was generated for display, and/or a time of day that the media asset was generated for display. For example, control circuitry may use the historical viewership information to predict viewership information at a scheduled time and day of an advertising event.

In some embodiments, control circuitry may compare the difference between the scheduled time of the retrieved advertising event and a current time to a second threshold that is greater than the first threshold. For example, control circuitry may implement a hybrid model using the first model configured for long-term prediction and the second model configured for short-term prediction. Control circuitry, in response to determining that the difference is greater than the first threshold and less than the second threshold, may compute a weighted average of the first predicted viewership information, and the second predicted viewership information. For example, control circuitry may weight the first predicted viewership information for long-term predictions greater than the second predicted viewership information for short-term predictions if the scheduled time of the advertising event is closer to the second threshold (e.g., further in time). Control circuitry may select the computed weighted average of the predicted viewership information as the estimated viewership information that is subsequently updated into the advertising queue for the advertising event.

In some embodiments, the first model is a support vector machine configured for predicting long-term viewership information. For example, the support vector machine may be parameterized with demographic information, but without information about a media asset that may be scheduled for display around the scheduled time of an advertising event because a media asset has not yet been scheduled.

In some embodiments, control circuitry may select a subset of the historical viewership information as a training time series data or training data samples (e.g., for training the support vector machine based model). For example, if ten weeks of viewership information is available, control circuitry may select the first nine weeks of viewership information as training data samples.

Control circuitry may select, as a target output, an entry from the historical viewership information that corresponds to a viewing activity that occurred after all viewing activities corresponding to the subset of the historical viewership information selected as the training data samples. For example, if ten weeks of viewership information are available, and the first nine weeks of viewership are selected for training data samples, the data of the last week of the ten weeks may be selected as the target output.

Control circuitry may apply a transformation function to the selected subset of training data samples to generate a transformed set of training data samples and may apply the same or different transformation function to the target output to generate a transformed target output. For example, a support vector machine may build a set of equations to approximate training datasets. These equations may define hyperplanes that traverse datapoints within the training data samples (e.g., via a form of regression). Support vector machines may more effectively operate on linear data than non-linear data. In cases where training data samples are non-linear, control circuitry may apply a transformation function to the training data samples and target output in order to map the training data and the target output into a high-dimension feature space where linear regression can be performed. Control circuitry may then input the transformed set of training data samples and the transformed target output into the support vector machine (e.g., to train the support vector machine).

In some embodiments, the second model is an artificial neural network configured for predicting short-term viewership information. For example, the artificial neural network may be parameterized with demographic information, and with information about a media asset that may be scheduled for display around the scheduled time of an advertising event because a media asset has been scheduled, as compared to the configuration of the support vector machine for the long-term prediction, which does not include the information about a media asset scheduled for display.

In some embodiments, the artificial neural network may be implemented as a feed-forward artificial neural network. For example, the artificial neural network may be implemented without feedback paths from successive layers of nodes to earlier layers of nodes. The artificial neural network may be implemented with at least three layers: an input layer, a hidden layer, and an output layer. The number of nodes in the input layer may depend on the number of lagged values of the time series, which are in turn determined by the AIC criterion (Akaike information criterion). For example, if the number of lagged values is nine, control circuitry may be configured to implement the input layer of the artificial neural network with nine input nodes.

In some embodiments, control circuitry may compute a number of hidden nodes in the hidden layer as the number of lagged values of the time series incremented by one and divided by two. For example, if the number of lagged values is nine, control circuitry may compute the number of hidden nodes as five. Control circuitry may then set the number of hidden nodes in the hidden layer to the computed number of hidden nodes. For example, control circuitry may be configured to implement the hidden layer of the artificial neural network with five hidden nodes.

In some embodiments, the artificial neural network may further include a first matrix of weights connecting input data and the input layer (e.g., first a matrix of weights applied to the input data of each input node at the input layer), a second matrix of weights connecting the input layer and the hidden layer (e.g., a second matrix of weights applied to the output of the input nodes of the input layer which are subsequently input into corresponding hidden nodes at the hidden layer) and a third matrix of weights connecting the hidden layer and the output layer (e.g., a third matrix of weights applied to the output the hidden nodes of the hidden layer which are subsequently input into corresponding output nodes in the output layer). For example, each node at each layer of the artificial neural network may have a number of inputs and an associated weight per input. For example, each of the input nodes in the input layer may have an input and an associated weight. In the case of an input layer with nine nodes and nine inputs (one per node), the input layer would have a corresponding matrix of nine weights (one per input node).

Control circuitry may select a subset of historical viewership information as training data samples (e.g., to train the artificial neural network).

For example, if ten weeks of viewership information is available, control circuitry may select the first nine weeks of viewership information) as training data samples. Control circuitry may select, as a target output, an entry from the historical viewership information that corresponds to a viewing activity that occurred after all viewing activities corresponding to the subset of the historical viewership information selected as the training data samples. For example, if ten weeks of viewership information are available, and the first nine weeks of viewership are selected for training data samples, the data of the last week of the ten weeks may be selected as the target output.

Control circuitry may first compute the lagged values of the training data samples and input the lagged values of the time series at the input layer. For example, control circuitry may select nine weeks of data as nine training data samples from historical viewership information including ten weeks of data, compute the lagged values as four, and finally input lagged values of the time series at the input layer. The training data samples may be input to corresponding input nodes based on chronological order of the training data samples. Control circuitry may compute an output based on the training data samples, the first matrix of weights, the matrix of weights, and the matrix of weights. For example, the first matrix of weights may correspond to the input data and the input layer, the second matrix of weights may correspond to the input layer and the hidden layer, and the third matrix of weights may correspond to the hidden layer and the output layer. The first matrix of weights, second matrix of weights and third matrix of weights may be initialized randomly. Control circuitry may scale each input at the input layer by a corresponding weight from the first matrix of weights and apply the input to a corresponding input node. Control circuitry may then compute one or more output values from each input node and propagate the computed outputs of each input node to inputs of specified hidden nodes in the hidden layer.

For each hidden node, control circuitry may scale respective inputs to the hidden node by corresponding weights from the second matrix of weights. Control circuitry may then compute one or more output values for each hidden node and propagate the computed outputs of each hidden node to inputs of one or more specified output nodes in the output layer. For each output node, control circuitry may scale respective inputs to the output node by corresponding weights from the third matrix of weights. Control circuitry may then compute one or more output values for each output node.

Control circuitry may adjust each weight within the second matrix of weights (e.g., corresponding to the input layer and the hidden layer) in order to minimize a difference between the computed output and the target output. For example, control circuitry may use the computed difference (e.g., error) to propagate back through the network layers in order to update one or more of the first matrix of weights, the second matrix of weights, or the third matrix of weights. For example, control circuitry may increase or decrease weights of the second matrix, corresponding to the input layers and the hidden layer, in order to adjust a computed output to better match the target output (e.g., the tenth week of historical viewership information when the first nine weeks of historical viewership information are used as training data samples).

In some aspects, the control circuitry of the system may retrieve an advertising event (e.g., corresponding to an interstitial advertisement that is to be aired during a morning time) from an advertising event queue, where the retrieved advertising event includes predicted viewership information that was determined using at least one of a first model configured for predicting long-term viewership information (e.g., a support vector machine based model) and a second model configured for predicting short-term viewership information (e.g., an artificial neural network based model) based on the historical viewership information. For example, control circuitry may retrieve an advertising event (e.g., an interstitial advertisement) that is scheduled less than four weeks from a current time, and is determined using an artificial neural network model configured for short-term predictions. For example, control circuitry may retrieve an advertising event (e.g., a banner advertisement) that is scheduled for display more than four weeks from a current time, and has predicted viewership information that was determined using a support vector machine based model configured for long-term predictions.

Control circuitry may issue a query command to a database for advertising requests that includes target viewership information that matches the predicted viewership information, and includes a target completion date of an advertising campaign associated with a respective advertising request and a percent completion of the advertising campaign associated with the respective advertising request. For example, the predicted viewership information of the advertising event may indicate that the demographic information of the predicted audience includes children aged 5-10. For example, advertising requests may include advertisements (e.g., interstitial advertisements) from one or more different advertising campaigns (e.g., from a car company to market cars to adults aged 18-35; from a first movie company to advertise an animated movie to children ages 5-10; from a second movie company to advertise a puppet movie to children ages 5-10). Each advertising request may include a target completion date (e.g., four weeks from a current time), and a percent completion (e.g., advertisement requests in the advertising campaign have been displayed to 40% of a targeted segment of viewers). The target completion date and percent completion may correspond to information stored with an advertising campaign associated with each advertising request.

Control circuitry may receive one or more advertising requests as the one or more results of the query from the database. For example, when predicted viewership information includes a predicted demographic of ages 5-10, control circuitry may receive advertising requests that include a first advertising request (e.g., an interstitial advertisement from the first movie company to advertise an animated movie to children ages 5-10) and a second advertising request (e.g., an interstitial advertisement from the second movie company to advertise a puppet movie to children ages 5-10).

Control circuitry may compute a metric for each advertising request of the results of the query that includes a weighted average of a percent difference of a target completion date of an advertising campaign associated with the advertising request and a current date, and a percent completion of the advertising campaign associated with the advertising request. For example, the first advertising request for the animated movie may have a target completion date of four weeks from a current time, and a percent completion of the advertising campaign of 50%. If equal weights are applied to each parameter, control circuitry may compute a metric of 0.5*4+0.5*50 for a metric of 27. For example, the second advertising request for the puppet movie may have a target completion date of five weeks from a current time, and a percent completion of an advertising campaign of 20%. If equal weights are applied to each parameter, control circuitry may compute a metric of 0.5*5+0.5*20 for a metric of 12.5.

Control circuitry may select the advertising request having the lowest computed metric. For example, in reference to the first advertising request discussed above having a computed metric of 27 and the second advertising request discussed above having a computed metric of 12.5, the control circuitry may select the second advertising request. Even though the second advertising request has a later completion date, because the percent completion of its associated advertising campaign is lower, its computed metric is lower.

Control circuitry may link an entry of the retrieved advertising event to an entry of the selected advertising event. For example, control circuitry may update an entry of the advertising event in the advertising event queue to include a unique identifier of the selected second advertising event. Control circuitry may vice versa update an entry of the second advertising request in the database for advertising requests to include a unique identifier of the retrieved advertising request.

In some embodiments, control circuitry may determine that the results of the query include no results. For example, in response to issuing the query command to the database for advertising requests that include target viewership information that matches the predicted viewership information (e.g., an audience of the demographic, ages 5-10), control circuitry may receive no search results. This may be caused by lack of direct matches between predicted viewership information of an advertising event and advertising requests.

Control circuitry may adjust parameters of the predicted viewership information of the retrieved advertising. For example, control circuitry may expand the age range of the demographic information from ages 5-10 to ages 5-15. Control circuitry may issue a second query command to the database for advertising requests that include target viewership information that is similar to the adjusted parameters of the predicted viewership information. For example, control circuitry may issue a query to the database for advertising requests that include target viewership that is similar to the adjusted viewership (e.g., demographic ages 5-15). Control circuitry adjusts the predicted viewership information in order to expand a potential set of matches.

For each advertising request of the results of the second query, control circuitry may compute a metric as a weighted average of a percent difference of a target completion date of an advertising campaign associated with the respective advertising request corresponding to the second query and a current date, and a percent completion of the advertising campaign associated with the respective advertising request corresponding to the second query. For example, a first advertising request result may correspond to a fantasy live-action movie targeted towards a demographic of ages 8-15, and may have a target completion date of six weeks from a current time, and a percent completion of the advertising campaign of 60%. If equal weights are applied to each parameter, control circuitry may compute a metric of 0.5*6+0.5*60 for a metric of 33. For example, a second advertising request result may correspond to a mystery live-action movie targeted towards a demographic of ages 8-15, and may have a target completion date of two weeks from a current date and a percent completion of an advertising campaign of 95%. If equal weights are applied to each parameter, control circuitry may compute a metric of 0.5*2+0.5*90 for a metric of 41.

Control circuitry may select the advertising request of the second query results that have a lowest computed metric. For example, control circuitry may select the first advertising request result of the second query, having a metric of 33, compared to the second advertising request result of the second query, having a metric of 41. Even though the second advertising request has a closer completion date, its campaign has a higher percentage completion.

In some embodiments, control circuitry may link the entry of the retrieved advertising event to the entry of the selected advertising request by updating an entry for the selected advertising request in the database to include an identifier of the linked advertising event, and by updating an entry for the advertising event in the advertising event queue to include an identifier of the linked advertising request. For example, control circuitry may update the entry of the retrieved advertising event in the advertising event queue to include a unique database identifier of the selected advertising request from the database of advertising requests. For example, control circuitry may update the entry of the retrieved advertising request in the database to include a unique database identifier of the retrieved advertising event from the advertising event queue.

In some embodiments, the predicted viewership information includes demographic information (e.g., age, gender, etc.), and a percentage of predicted viewers from an audience corresponding to the demographic group (e.g., 20% of all audience members that are aged 18-49).

In some embodiments, the first model is a support vector machine configured for predicting long-term viewership information. For example, the support vector machine may be parameterized with demographic information, but not with information about a media asset that may be scheduled for display around the scheduled time of an advertising event because a media asset has not yet been scheduled.

In some embodiments, control circuitry may select a subset of the historical viewership information as training data samples (e.g., for training the support vector machine based model). For example, if ten weeks of viewership information is available, control circuitry may select the first nine weeks of viewership information) as training data samples.

Control circuitry may select, as a target output, an entry from the historical viewership information that corresponds to a viewing activity that occurred after all viewing activities corresponding to the subset of the historical viewership information selected as the training data samples. For example, if ten weeks of viewership information are available, and the first nine weeks of viewership are selected for training data samples, the data of the last week of the ten weeks may be selected as the target output.

Control circuitry may apply a transformation function to the selected subset of training data samples to generate a transformed set of training data samples and may apply the same or different transformation function to the target output to generate a transformed target output. For example, a support vector machine may build a set of equations to approximate training datasets. These equations may define hyperplanes that traverse the datapoints within the training data samples (e.g., via a form of regression). Support vector machines may more effectively operate on linear data than non-linear data. In cases where training data samples are non-linear, control circuitry may apply a transformation function to the training data samples and target output in order to map the training data and the target output into a high-dimension feature space where linear regression can be performed. Control circuitry may then input the transformed set of training data samples and the transformed target output into the support vector machine (e.g., to train the support vector machine).

In some embodiments, the second model is an artificial neural network configured for predicting short-term viewership information. For example, the artificial neural network may be parameterized with demographic information, and with information about a media asset that may be scheduled for display around the scheduled time of an advertising event because a media asset has been scheduled, as compared to the configuration of the support vector machine for the long-term prediction, which does not include the information about a media asset scheduled for display.

In some embodiments, the artificial neural network may be implemented as a feed-forward artificial neural network. For example, the artificial neural network may be implemented without feedback paths from successive layers of nodes to earlier layers of nodes. The artificial neural network may be implemented with at least three layers: an input layer, a hidden layer, and an output layer. The number of nodes in the input layer may depend on the number of lagged values of the time series, which are in turn determined by the AIC criterion (Akaike information criterion). For example, if the number of lagged values is nine, control circuitry may be configured to implement the input layer of the artificial neural network with nine input nodes.

In some embodiments, control circuitry may compute a number of hidden nodes in the hidden layer as the number of lagged values of the time series incremented by one and divided by two. For example, if the number of lagged values is nine, control circuitry may compute the number of hidden nodes as five. Control circuitry may then set the number of hidden nodes in the hidden layer to the computed number of hidden nodes. For example, control circuitry may be configured to implement the hidden layer of the artificial neural network with five hidden nodes.

It should be noted that the systems, methods, apparatuses, and/or aspects described above may be applied to, or used in accordance with, other machine learning techniques (e.g., fourier transforms, Bayesian linear regression, etc.), systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application for selecting media assets in accordance with some embodiments of the disclosure;

FIG. 2 shows an illustrative media guidance application that may be used to adjust user settings in accordance with some embodiments of the disclosure;

FIG. 3 is a block diagram of an illustrative media system in accordance with some embodiments of the disclosure;

FIG. 4 is a block diagram of an illustrative media system in accordance with some embodiments of the disclosure;

FIG. 5 is a flowchart of an algorithm for predicting viewership information at a future time for an advertising event in accordance with some embodiments of the disclosure;

FIG. 6 illustrates pseudocode that describes the algorithm for predicting viewership information at a future time for an advertising event in accordance with some embodiments of the disclosure;

FIG. 7 is a flowchart of an algorithm describing an algorithm for matching advertising events to advertising requests based on predicted viewership information for an advertising event, and requested viewership information in an advertising request in accordance with some embodiments of the disclosure;

FIG. 8 illustrates pseudocode describing an algorithm for matching advertising events to advertising requests based on predicted viewership information for an advertising event, and requested viewership information in an advertising request in accordance with some embodiments of the disclosure;

FIG. 9 illustrates a diagram of an artificial neural network in accordance with some embodiments of the disclosure;

FIGS. 10-12 illustrate results of experiments for prediction of viewership information using artificial neural networks in accordance with some embodiments of the disclosure;

FIG. 13 illustrates a table of error rates for results of experiments for predicting viewership information using artificial neural networks in accordance with some embodiments of the disclosure;

FIG. 14 illustrates an example of an implementation of a support vector machine in accordance with some embodiments of the present disclosure;

FIG. 15 illustrates an example of an implementation of a support vector machine that uses transformation of input data in accordance with some embodiments of the disclosure;

FIG. 16 illustrates time series data having high variance that can be modeled by a support vector machine in accordance with some embodiments of the disclosure;

FIGS. 17-20 illustrates results of experiments for prediction of viewership information in accordance with some embodiments of the disclosure;

FIG. 21 is a flowchart of a process for predicting viewership information at a future time for an advertising event in accordance with some embodiments of the disclosure; and

FIG. 22 is a flowchart of a process for matching advertising requests to advertising events based on predicted viewership information of the advertising events.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

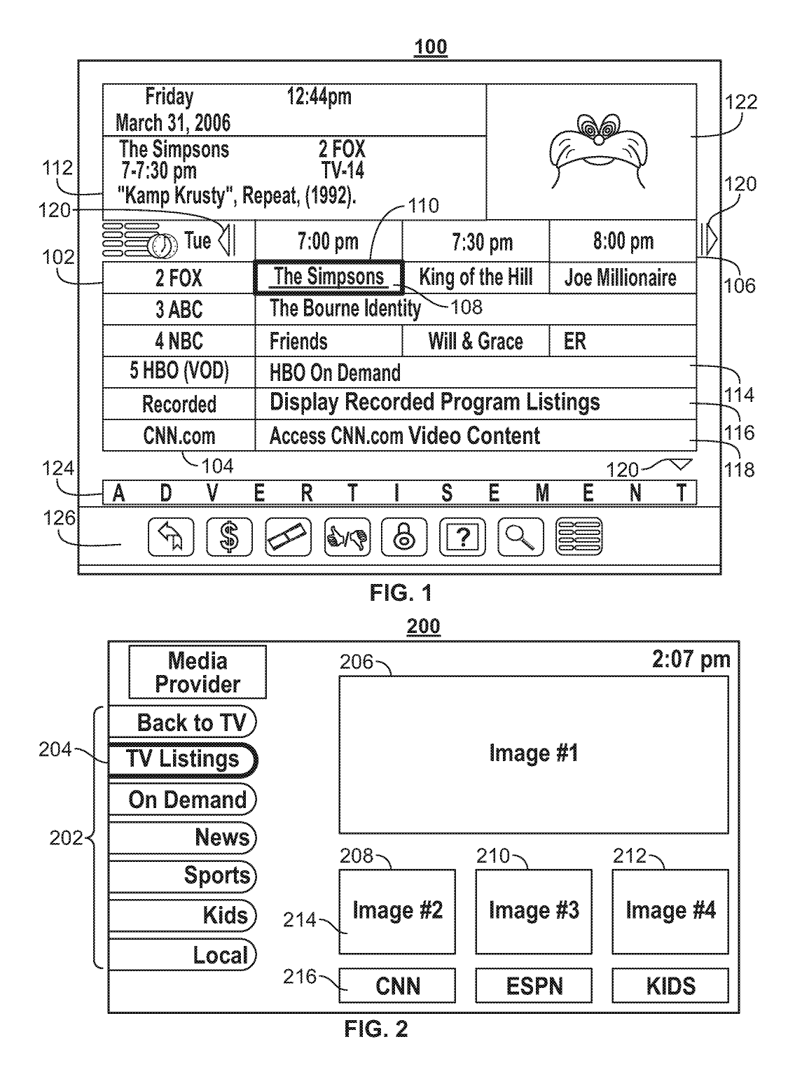

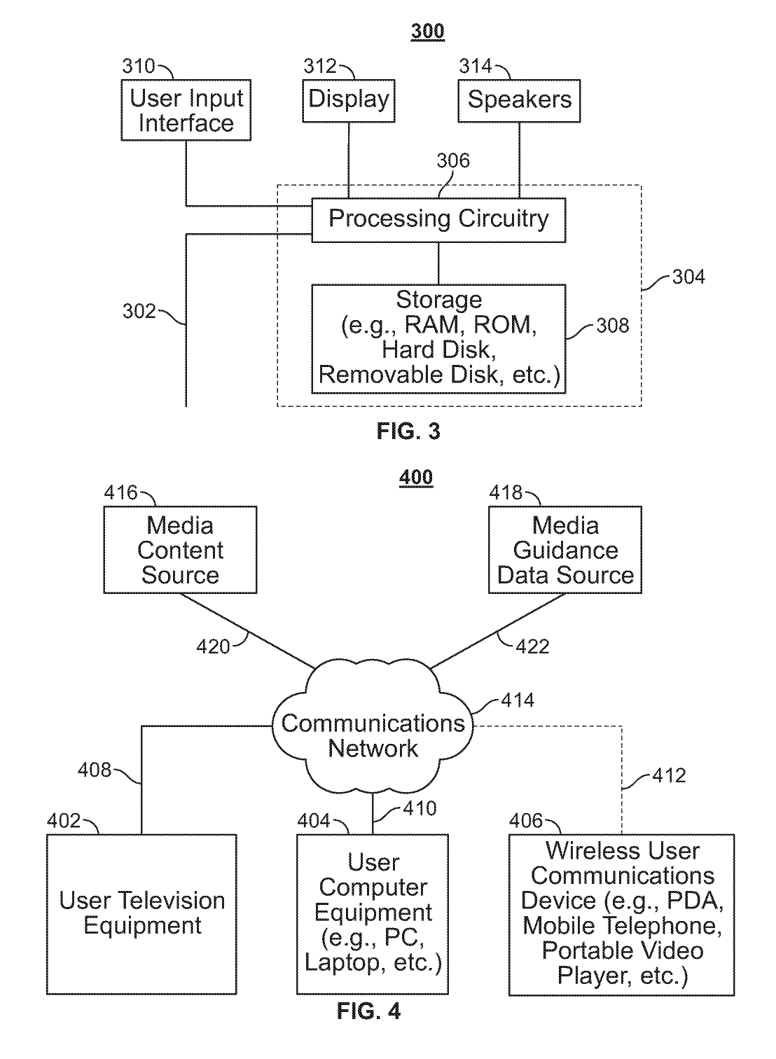

Another function of the media guidance application is to provide targeted advertising to users. The advertising may include content or multimedia that is presented to users as part of a display of the media guidance application as described below in reference to FIGS. 1-2. The times and locations within media guidance application displays during which said advertising is displayed may be selected based on predictions of user behavior based on prior user interactions with the media guidance application.

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126.

Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Advertisements may also refer to interstitial advertisements that are generated for display during display of a media asset. Each advertisement may be described as an advertising event. As referred to herein, an “advertising event” should be understood to include information about the type of advertisement (e.g., interstitial advertisement, banner advertisement, etc.), time of display of the advertisement (e.g., a time stamp), and context of the advertisement (e.g., related media assets that are contemporaneously displayed). Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties.

It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

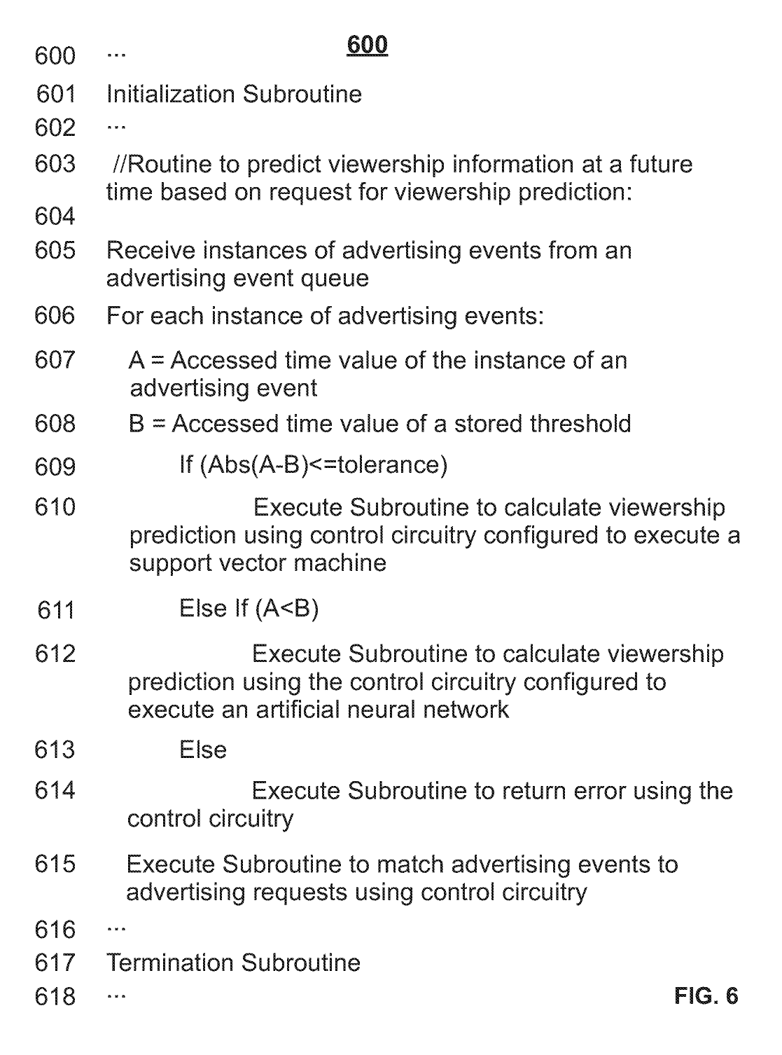

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

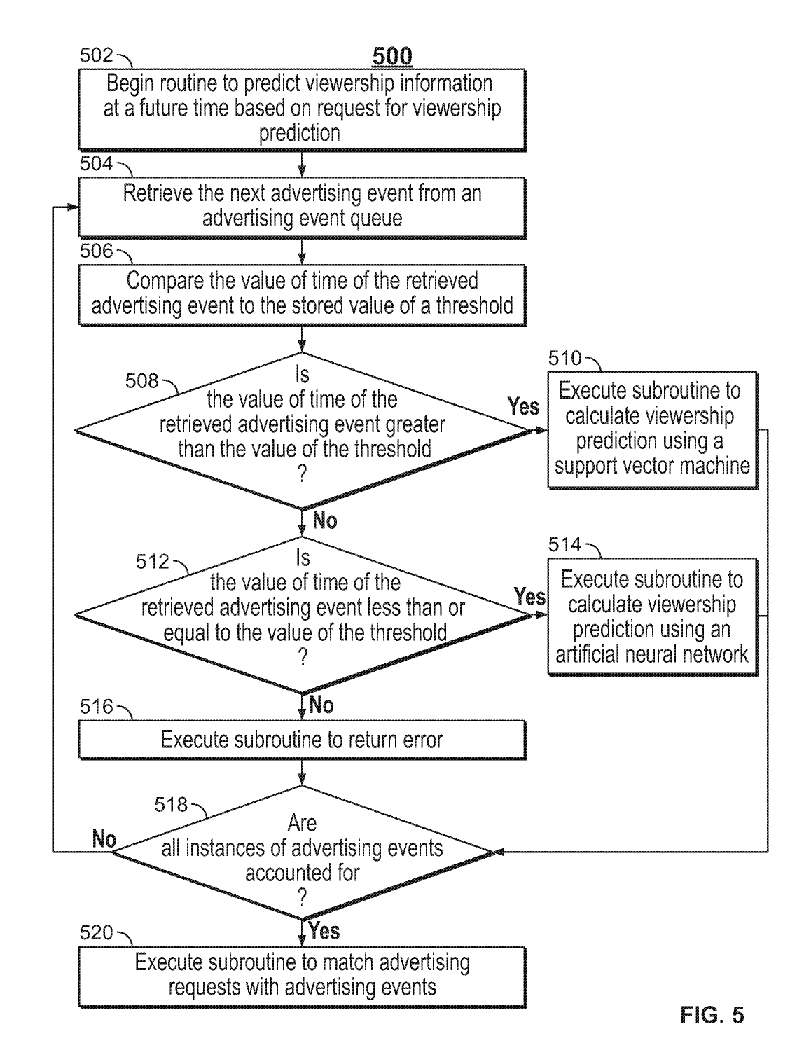

As an example, the media guidance application may collect Nielsen ratings to determine viewership information for an audience of media assets or time slots. The Nielsen ratings may include demographic information about viewers (e.g., age, sex, income level, etc.) within an audience and information about a viewed media asset (e.g., title, genre, parental control rating, etc.). The Nielsen ratings may be measured by self-reporting by viewers, or may be monitored through viewer interactions with a media guidance application (e.g., by monitoring the duration of media assets that have been watched by the viewer, or the manner in which the media assets have been watched, such as live or DVR playback, etc.). In some embodiments, the Nielsen ratings may be collected by a user equipment device (e.g., any user equipment device described in reference to FIG. 3 or FIG. 4 further below). The Nielsen ratings may be processed as part of an advertising campaign to target advertising to a set of viewers that are part of a targeted demographic (e.g., 18-49 year old persons who have watched a certain program either live or same day from a DVR [LIVE+SD], etc.).

As referred to herein, an “advertising campaign” should be understood to be a plan for targeting advertisements to a target audience, where the plan includes one or more advertising requests, target viewership information for the target audience (e.g., demographic information, a target exposure of the audience to advertising by the advertising campaign, quantified by TRPs or GRPs as discussed below), a campaign completion date (e.g., date at which the advertising campaign should reach the target exposure), and a percentage completion (e.g., a fraction of the target exposure that has been achieved). As referred to herein, an “advertising request” should be understood to mean one or more advertisements (e.g., a banner advertisement, channel advertisement, interstitial advertisement, etc.) associated with an advertising campaign. An advertising request may include or link to data fields of the associated advertising campaign (e.g., the campaign completion date, target viewership information, any other suitable information or any combination thereof). An advertising request may also include requirements for conditions for display (e.g., minimum duration of display, etc.).

Performance of an advertising campaign may be quantified by gross rating points (GRPs) and/or target rating points (TRPs). A GRP represents an accumulation of proportions of a given audience that has viewed advertisements from an advertising campaign over a specific interval. For example, if 25% of a given audience has viewed advertisements of an advertising campaign five times within a show, then the advertising campaign would have a metric of 125 GRPs for the interval of the show, computed as the number of times the given audience has viewed the relevant advertisements multiplied by the percentage of the given audience. Other intervals such as week, month or day may apply as well.

A TRP represents a percentage of the target audience that is reached by an advertisement. It is determined by multiplying the reach of an advertisement (e.g., the percentage of a target audience to whole audience), by a GRP for an advertisement. For example, if the GRP for an advertising campaign is 125, and the target audience is 10% of the total population, the TRP would be 125*0.1, which results in a metric of 12.5 TRPs. An advertising campaign may be designed such that a certain number of GRPs or TRPs is achieved.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server.

Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

In some embodiments, media content source 416 may include a database of advertising events (e.g., an unordered list of advertising events, an advertisement queue including an ordered list describing a sequence of advertising events, etc.). In some embodiments, the database of advertisement events may be implemented wholly or in part on user equipment. For example, a database of advertising events on user equipment may include advertising events for banner advertisements within a media guidance application while a database of advertising events implemented on content source 416 may include advertising events (e.g., interstitial advertisements) for scheduled or unscheduled media assets. Each advertising event in the database of advertising events may be matched to a database of requested advertisements.

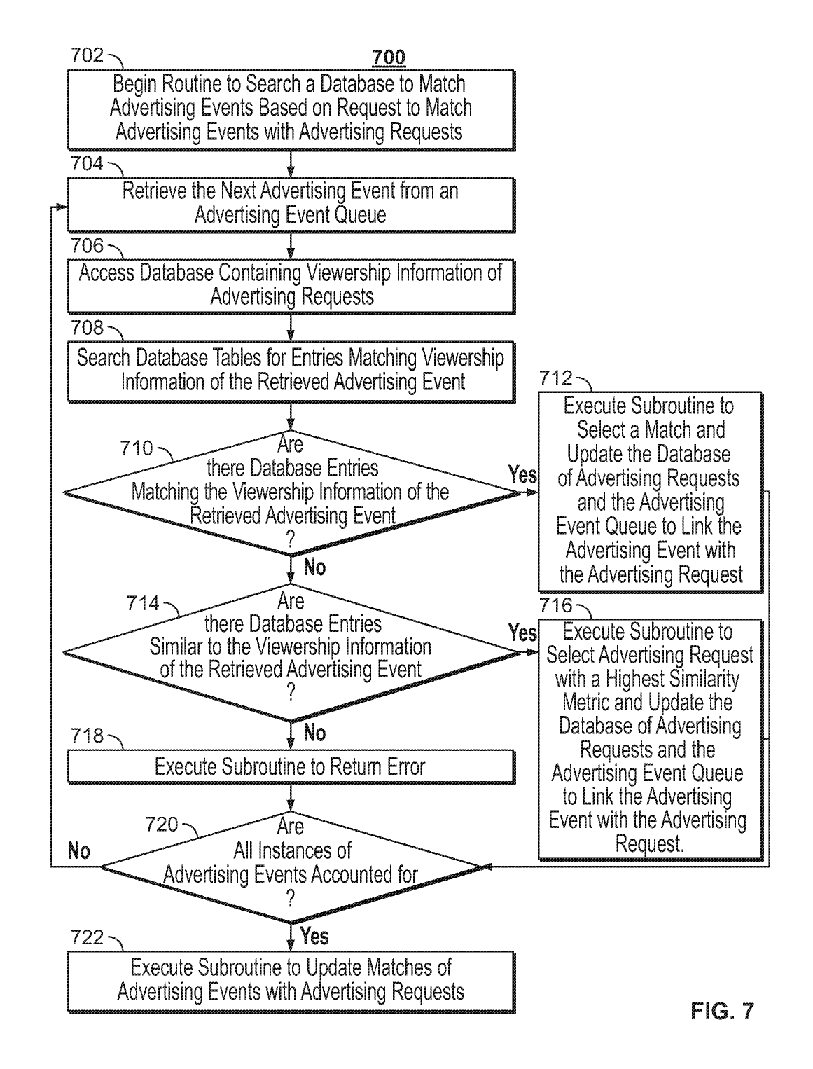

In some embodiments, a database of advertising requests may be stored at a server (not shown), at media content source 416, or any user equipment (e.g., 402, 404, or 406 illustrated in FIG. 4). The database of advertising requests may be generated and/or updated in response to receiving requests for advertising campaigns from an advertiser. For example, an advertiser may issue a request for an advertisement campaign that has a cumulative GRP target of 1000 over the period of a month. The advertising request may specify demographic information for a target audience (e.g., age group 18-49, who watch live and same day). The advertising request may be matched to advertising events, as described further below in reference to FIGS. 5-8.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections.

OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

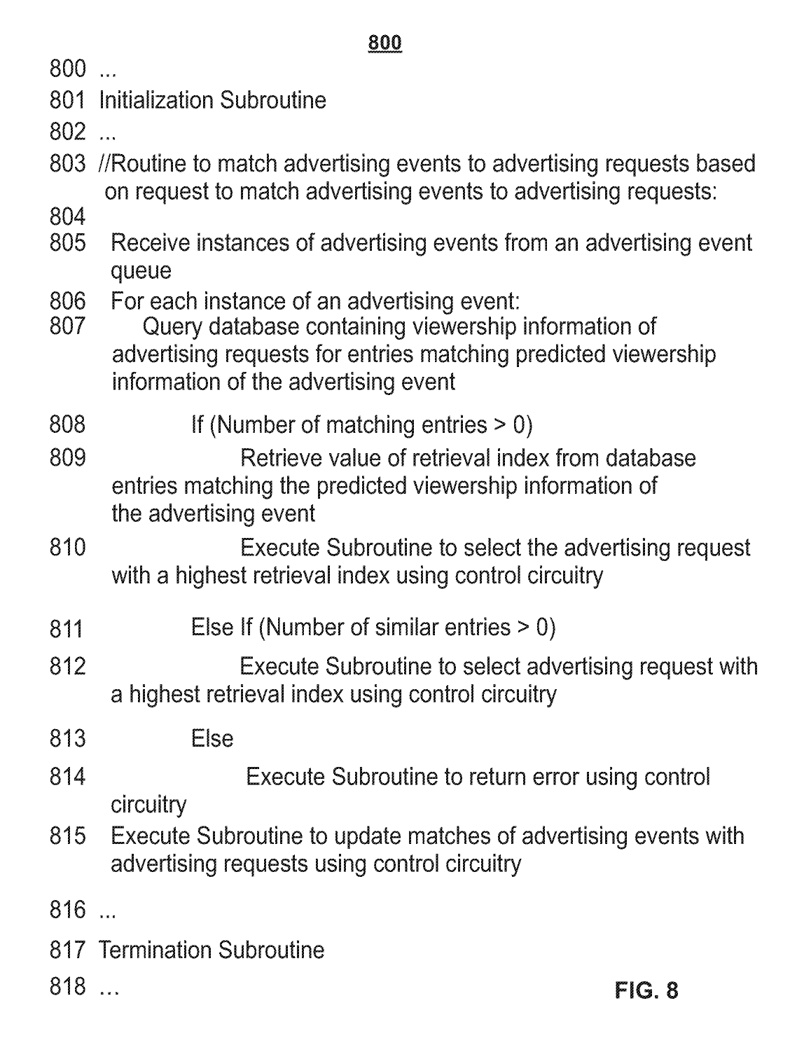

FIGS. 5 and 6 present an algorithm for control circuitry (e.g., control circuitry 304) to predict viewership information for an advertising event at a future time based on a request for viewership prediction in accordance with some embodiments of the disclosure. In some embodiments this algorithm may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 5 describes an algorithm for control circuitry (e.g., control circuitry 304) to predict viewership information for an advertising event at a future time in accordance with some embodiments of the disclosure.

At step 502, the algorithm to predict viewership for an advertising event at a future time will begin based on a request for viewership prediction. In some embodiments, this may be done either directly or indirectly in response to a user action or input (e.g., from signals received by control circuitry 304 or user input interface 310). For example, the algorithm may begin directly in response to control circuitry 304 receiving signals from user input interface 310, or control circuitry 304 may prompt the user to confirm their input using a display (e.g., by generating a prompt to be displayed on display 312) prior to running the algorithm. In some embodiments, control circuitry may perform step 502 automatically at periodic or aperiodic intervals (e.g., weekly, or monthly), based on a number of advertising events being added to advertising events of an advertising event queue.

At step 504, control circuitry 304 proceeds to retrieve the next instance of an advertising event or other database of advertising events from an advertising event queue. In some embodiments control circuitry 304 may receive a single primitive data structure that represents the value of a time of an advertising event (e.g., a scheduled time for display of an interstitial advertisement during a scheduled broadcast of a media asset, a scheduled time for display of a banner advertisement in a media guidance application, etc.). In some embodiments the value may be stored as part of a larger data structure, and control circuitry 304 may retrieve the value by executing appropriate accessor methods to retrieve the value from the larger data structure.

At step 506, control circuitry 304 proceeds to compare the value of the time of the retrieved advertising event to the stored value of a threshold (e.g., a specified future time, a specified past time, or a current time). This comparison may be used to select between various approaches for predicting viewership information (e.g., between an ANN approach, an SVM approach, fourier transform approach, Bayesian linear regression approach, hybrid approach, any other suitable approach or any combination thereof). In some embodiments, the value of the time of the retrieved advertising event may be stored (e.g., on storage device 308) prior to beginning the algorithm. In some embodiments the value of the time of the retrieved advertising event may also be retrieved for each and every instance of advertising events from the advertising event queue (or other database of advertising events), and the value of the threshold may change from iteration to iteration.

For example, the threshold (e.g., the specified time) of the advertising event may change based on the type of advertising event (e.g., an interstitial advertisement, banner advertisement, etc.). In some embodiments, the predictive accuracy of the ANN or SVM approach may vary based on the type of advertising event. For example, an ANN approach may have a higher predictive accuracy for a shorter time horizon than an SVM approach or vice versa. The different thresholds may be stored with a respective advertising event. Accordingly, control circuitry may retrieve a threshold from the advertising event that is higher for an interstitial advertisement, and that is lower for a banner advertisement. In some embodiments, control circuitry 304 may directly compare the value of the time of the advertising event with the value of the threshold by accessing the values respectively from memory and performing a value comparison. In some instances, control circuitry 304 may call a comparison function (e.g., for object to object comparison) to compare the time of the advertising event and the threshold.

At step 508, control circuitry 304 compares the values of the time of the advertising event and the threshold to determine if the value of the time of the advertising event is greater than the value of the threshold. If the condition is satisfied, the algorithm may proceed to step 510; if the condition is not satisfied, the algorithm may proceed to step 512 instead.

At step 510, control circuitry 304 will execute a subroutine to compute viewership prediction using an approach suitable for long time horizons (e.g., using an SVM approach) based on the condition at step 508 being satisfied. In some embodiments, control circuitry 304 will use a hybrid approach (e.g., combining an SVM approach, ANN approach, any other machine learning technique, or any combination thereof) that weighs the SVM approach suitable for longer time horizons more heavily than the ANN approach suitable for shorter time horizons. After the subroutine is executed, the algorithm may proceed to step 518 where it is determined if all instances of advertising events in the advertising event queue (or other database of advertising events) are accounted for and further iterations are needed.

At step 512, control circuitry 304 compares the values of the time of the advertising event and the threshold to determine if the value of the time of the advertising event is less than or equal to the value of the threshold. If the condition is satisfied, the algorithm may proceed to step 514; if the condition is not satisfied, the algorithm may proceed to step 516 instead.

At step 514, control circuitry 304 will execute a subroutine to compute viewership predictions using an approach suitable for short time horizons (e.g., using an ANN approach) based on the condition of step 512 being satisfied. In some embodiments, control circuitry 304 may use a hybrid approach that combines an SVM and ANN approach, and weighs the ANN approach suitable for short time horizons more heavily. After the subroutine is executed, the algorithm may proceed to step 518 where it is determined if all instances of the advertising events in the advertising event queue are accounted for and if further iterations are needed.

At step 516, control circuitry 304 will execute a subroutine to return an error based on both of the conditions in 508 and 512 not being satisfied. After the subroutine is executed, the algorithm may proceed to 518 where it is determined if all instances of advertising events in an advertising event queue are accounted for and if further iterations are needed.

At step 518, control circuitry 304 will check if all instances of the advertising events in the advertising event queue are accounted for. If all of the instances have been evaluated, control circuitry 304 may proceed to step 520. For example, control circuitry 304 may call a function to see if there is a next element of an advertising event on the advertising event queue. If the function returns true (i.e., there are still instances that need to be processed), control circuitry 304 may proceed to step 504.

At step 520, control circuitry 304 will execute a subroutine to match advertising requests with advertising events based on the predicted viewership information.

It is contemplated that the descriptions of FIG. 5 may be used with any other embodiment of this disclosure. In some embodiments, the algorithm described in FIG. 5 may operate on a specified type of advertising event per iteration. In addition, the descriptions described in relation to the algorithm of FIG. 5 may be done in alternative orders or in parallel to further the purposes of this disclosure. For example, conditional statements and logical evaluations, such as those at 508 and 512, may be performed in any order or in parallel or simultaneously to reduce lag or increase the speed of the system or method. As a further example, in some embodiments several instances of advertising events may be evaluated in parallel, using multiple logical processor threads, or the algorithm may be enhanced by incorporating branch prediction.

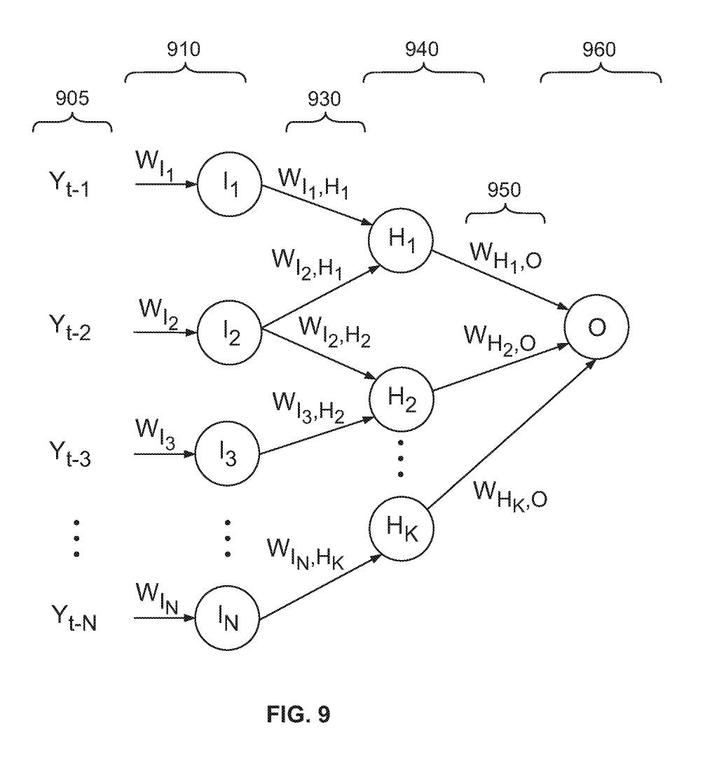

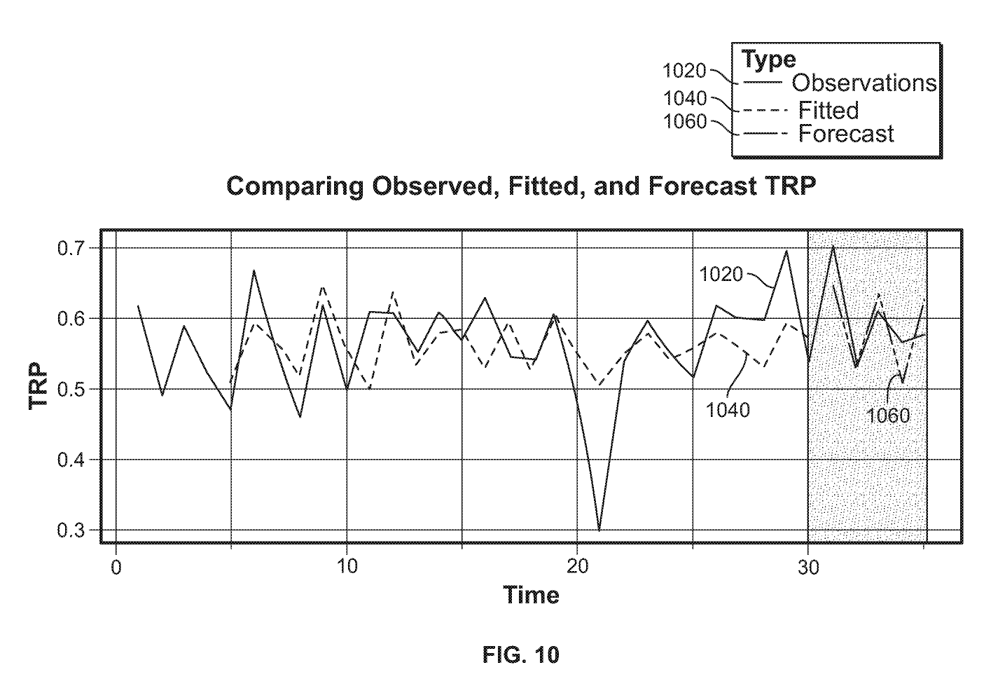

In some embodiments, the algorithm may terminate at step 520. For example, the algorithm described in FIG. 5 may run as a background process that is periodically invoked. The algorithm to match advertising request with advertising events (described further below in reference to FIGS. 7-8) may run as a separate process such that the process to determine predicted viewership information for advertising events may be run in parallel with the process to match advertising events to advertising requests. Furthermore, it should be noted that the algorithm of FIG. 5 may be implemented on a combination of appropriately configured software and hardware, and that any of the devices or equipment discussed in relation to FIGS. 3-4 could be used to implement one or more portions of the algorithm.

The pseudocode in FIG. 6 describes an algorithm to predict viewership information in accordance with some embodiments of the disclosure. It will be evident to one skilled in the art that the algorithm described by the pseudocode in FIG. 6 may be implemented in any number of programming languages and a variety of different hardware, and that the style and format should not be construed as limiting, but rather a general template of the steps and procedures that would be consistent with code used to implement some embodiments of this disclosure.

At line 601, the algorithm may run a subroutine to initialize variables and prepare to predict viewership information, which begins on line 605. For example, in some embodiments control circuitry 304 may copy instructions from non-transitory storage medium (e.g., storage device 308) into RAM or into the cache for processing circuitry 306 during the initialization stage. Additionally, in some embodiments the value of a threshold (e.g., a specified future time, specified past time, or a current time) being used for comparison, or a tolerance level for determining if two values are essentially equivalent, may be retrieved, set, and stored at 601.

At line 605, control circuitry 304 may receive instances of advertising events. In some embodiments these instances may be retrieved from an advertising event queue or other database of advertising events stored in storage 308, media content source 416 or any other suitable server, or storage. Control circuitry 304 may receive instances of advertising events by receiving, for example, a pointer to an array of values of advertising events. In another example, control circuitry 304 may receive an object of a class, such as an iterator object containing elements of advertising events.

At line 606, control circuitry 304 may iterate through the various instances of advertising events, if only a single instance is available, the loop will only execute once. This loop may be implemented in multiple fashions depending on the choice of hardware and software language used to implement the algorithm of FIG. 6; for example, this may be implemented as part of a “for” or “while” loop.

At line 607, control circuitry 304 will store the value of a time of the advertising event into a temporary variable “A.” In some embodiments the value of the time of the advertising event will be stored as part of a larger data structure or class, and the value of the time of the advertising event may be obtained through appropriate accessor methods. In some embodiments the time of the advertising event may be converted from a string or other non-numeric data type into a numeric data type by means of an appropriate hashing algorithm. In some embodiments, control circuitry 304 may call a function to perform a comparison of the time of the advertising event to a threshold. In some embodiments the time of the advertising event may be encoded as a primitive data structure, and rather than using a temporary variable, the time of the advertising event may be directly used in the comparisons at lines 609 and 611.

At line 608, control circuitry 304 will store the value of threshold into a temporary variable “B.” Similar to the time of the advertising event, in some embodiments the value of the threshold will be stored as part of a larger data structure or class, and the value of the threshold may be obtained through accessor methods. In some embodiments the time of the advertising event may be converted from a string or other non-numeric data type into a numeric data type by means of an appropriate hashing algorithm, or the threshold may be a primitive data structure, and may be directly used in the comparisons at lines 609 and 611.

At line 609, control circuitry 304 compares the value of A to the value of B to determine if A is greater than B. This may be achieved by subtracting the value of B from A, taking the absolute value of the difference, and then comparing the absolute value of the difference to a predetermined tolerance level. In some embodiments the tolerance level may be a set percentage of either A or B. In some embodiments the tolerance level may be a fixed number. For example, setting the tolerance level to a set multiple of machine epsilon may allow for the algorithm to account for small rounding errors that may result from the use of floating point arithmetic. In some embodiments the tolerance level may be set to zero, or the condition inside the IF statement may be replaced with a strict equivalence between A and B.

At line 610, control circuitry 304 will execute a subroutine to compute a prediction of viewership information using control circuitry configured to execute a prediction approach suitable for long time horizons (e.g., an SVM approach) if the condition in line 609 is satisfied. In some embodiments, control circuitry may use a hybrid approach that combines an ANN approach and SVM approach, and weighs the SVM approach suitable for long time horizons more heavily. In some embodiments this may be achieved by processing circuitry 306 receiving instructions from storage 308.

At line 611, control circuitry 304 will compare the value of A and B to determine if A is less than B. In some embodiments this comparison will only be done if A is not greater than B and the comparison in line 609 evaluates to FALSE.

At line 612, control circuitry 304 will execute a subroutine to compute a prediction of viewership information using control circuitry configured to execute an approach suitable for short time horizons (e.g., an ANN approach) if the condition in line 611 is satisfied. In some embodiments, control circuitry may use a hybrid approach that combines an ANN approach and SVM approach, and weighs the ANN approach suitable for short time horizons more heavily.

At line 613, control circuitry 304 will determine whether neither condition in line 609 or 611 are satisfied. If neither condition is satisfied, then the instruction at line 614 may be evaluated and executed.

At line 614, control circuitry 304 will execute a subroutine to return an error using control circuitry if neither of the conditions at lines 609 or 611 are satisfied.

At line 616, control circuitry 304 may run a termination subroutine after the algorithm has performed its function. For example, in some embodiments control circuitry 304 may destruct variables, perform garbage collection, free memory or clear the cache of processing circuitry 306.

It will be evident to one skilled in the art that the algorithm described by the pseudocode in FIG. 6 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed after lines 610 and 612 to speed operation, or the conditional statements may be replaced with a case-switch. In some embodiments, rather than iterating over all instances of advertising events at step 506, in some embodiments the code may be rewritten so control circuitry 304 is instructed to evaluate multiple instances of advertising events simultaneously on a plurality of processors or processor threads, lowering the number of iterations needed and potentially speeding up computation time.

FIGS. 7 and 8 present an algorithm for control circuitry (e.g., control circuitry 304) to match advertising events to advertising requests (e.g., as part of an advertising campaign) using a database containing predicted viewership information (e.g., as computed in reference to FIGS. 5-6) of advertising events in accordance with some embodiments of the disclosure. Similar to the algorithms described by FIGS. 5 and 6, in some embodiments this algorithm may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 7 describes an algorithm for control circuitry (e.g., control circuitry 304) to search a database and match advertising events and advertising requests (e.g., from a sponsor of an advertising campaign) in accordance with some embodiments of the disclosure.

At step 702, the algorithm to search a database and match advertising events with advertising requests will begin based on a request to match advertising events with advertising requests (e.g., as received from a sponsor of an advertising campaign). In some embodiments, this may be done either directly or indirectly in response to a user action or input (e.g., from signals received by control circuitry 304 or user input interface 310.) In some embodiments, this may be done automatically at periodic or aperiodic intervals (e.g., in response to receiving new advertising events, or new advertising requests).

At step 704, control circuitry 304 proceeds to retrieve the next instance of an advertising event from an advertising event queue. In some embodiments control circuitry 304 may retrieve a single primitive data structure that represents the value of predicted viewership information. In some embodiments control circuitry 304 may retrieve the value from a larger class or data structure.

At step 706, control circuitry 304 accesses a database containing target viewership information of advertising requests. In some embodiments, this database may be stored locally (e.g., on storage device 308) prior to beginning the algorithm. In some embodiments the database may also be accessed by using communications circuitry to transmit information across a communications network (e.g., communications network 414) to a database implemented on a remote storage device (e.g., media guidance data source 418).

At step 708, control circuitry 304 searches database tables for entries matching predicted viewership information (e.g., demographic information) of the advertising event retrieved in step 704. In some embodiments this may be done by comparing an identifier, for example a string or integer representing the predicted viewership information, that matches the types of identifiers used inside the database. In some embodiments control circuitry 304 may submit a general query to the database for table entries matching the predicted viewership information, and control circuitry 304 may receive a list of indices or a data structure containing a portion of the database contents. In some embodiments the database may implement a junction table that in turn cross-references entries from other databases. In this case, control circuitry 304 may retrieve indices from a first database that in turn can be used to retrieve information from a second database. Although we may describe control circuitry 304 interacting with a single database for purposes of clarity, it is understood that the algorithm of FIG. 7 may be implemented using multiple independent or cross-referenced databases.

At step 710, control circuitry 304 may determine if there are database entries matching the predicted viewership information of the retrieved advertising event. In some embodiments control circuitry 304 may receive a signal from the database indicating that there are no matching entries. In some embodiments control circuitry 304 may instead receive a list of indices or data structures with a NULL or dummy value. If control circuitry 304 identifies that there are database entries matching the predicted viewership information the algorithm proceeds to step 712, otherwise the algorithm proceeds to step 714.

At step 712, control circuitry 304 will execute a subroutine to select a match and update the database of advertising requests and the advertising event queue to link the advertising event with a selected advertising request. Afterwards, the algorithm may proceed to step 720 where it is determined if there are further instances of advertising events that need to be accounted for. The control circuitry 304 may select the match based on parameters included in an advertising request. For example, an advertising request may include parameters such as requirements for an advertising event (e.g., minimum duration of an advertisement, target demographics [e.g., age range 18-49]) and tie-breaker parameters for selecting among multiple candidates that meet the requirements (e.g., campaign completion date, and percentage campaign completion (e.g., by number of GRPs)). Control circuitry 304 may select one or more advertising requests as candidates to link with the advertising event (e.g., match an advertising request for a car advertising campaign with an advertising event, such as an interstitial advertisement during a broadcast of a car race) that meets the minimum duration requirement and has predicted viewership that meets the target demographics.

If control circuitry 304 determines that more than one advertising request meets the requirements, control circuitry may select one of those advertising events based on the tie-breaker parameters. For example, control circuitry 304 may compute a weighted average based on the tie breaker parameters in order to favor advertising requests that have near-term completion dates and a low percentage of campaign completion. Control circuitry 304 may compute a weighted average of the percent difference between a current date and the completion date (e.g., (completion date−current date)/current date) and the percentage of campaign completion. Control circuitry may select the advertising request having the lowest weighted average.

At step 714, control circuitry 304 may determine if there are database entries similar to the predicted viewership information. For example, in some embodiments, if the predicted viewership information is encoded as a string with multiple characters, control circuitry 304 may perform additional database queries for similar strings with individual characters replaced, removed or added. For example, instead of searching for a demographic of 18-49 year olds, control circuitry 304 may search for a demographic of 21 to 55 year olds. In some embodiments control circuitry 304 may also determine if the original query was a commonly misspelled word, and will submit a query with the correct spelling instead. In another example, the predicted viewership information may be encoded as an integer; control circuitry 304 may perform additional queries for other integers within a certain range. In some embodiments control circuitry 304 may retrieve database entries similar to the predicted viewership information, without requiring further queries. If control circuitry 304 identifies that there are database entries similar to the predicted viewership information the algorithm proceeds to step 716; otherwise the algorithm proceeds to step 718.

At step 716, control circuitry 304 will execute a subroutine to select an advertising request with a highest similarity metric and update the database of advertising requests and the advertising event queue to link the advertising event with the advertising request. For example, control circuitry may compute a metric that determines the number of matches of the fields of the predicted viewership information and the other requirement parameters of the advertising request. If multiple candidates are found, control circuitry may select one candidate based on the tie breaker parameters in the advertising requests as discussed above in reference to step 712. Afterwards, the algorithm may proceed to step 720.

At step 718, control circuitry 304 will execute a subroutine to return an error after determining that there were no matching database entries for the predicted viewership information. Afterwards, the algorithm may proceed to step 720.

At step 720, control circuitry 304 will determine if all instances of the advertising events are accounted for and if further iterations are needed. If further iterations are needed the algorithm will loop back to step 704 where control circuitry 304 will retrieve the next instance of an advertising event. If no further iterations are needed the algorithm will proceed to step 722.

At step 722, control circuitry 304 may execute a subroutine to update matches of advertising events with advertising requests. Control circuitry may update a database entry for an advertising event with an identifier for a matched advertising request (e.g., a unique identifier from an entry of a database of advertising requests) and may update a database entry for an advertising request with an identifier from a matched advertising event. In this way, as advertising events are later executed as the time of the advertising event reaches a current time, an advertisement corresponding to the advertising request may be retrieved and generated for display.

It is contemplated that the descriptions of FIG. 7 may be used with any other embodiment of this disclosure. In addition, the descriptions described in relation to the algorithm of FIG. 7 may be done in alternative orders or in parallel to further the purposes of this disclosure. For example, control circuitry 304 may submit multiple queries to the database in parallel, or it may submit multiple queries to a plurality of similar databases in order to reduce lag and speed the execution of the algorithm. As a further example, although step 712 and step 716 are described as being mutually exclusive, both exact entries and similar entries may be processed for a single instance of an advertising event. To further this purpose, in some embodiments step 710 and step 714 may be performed in parallel by control circuitry 304. Furthermore, it should be noted that the algorithm of FIG. 7 may be implemented on a combination of appropriately configured software and hardware, and that any of the devices or equipment discussed in relation to FIGS. 3-4 could be used to implement one or more portions of the algorithm.

The pseudocode in FIG. 8 describes an algorithm to match advertising events with advertising requests in accordance with some embodiments of the disclosure. It will be evident to one skilled in the art that the algorithm described by the pseudocode in FIG. 8 may be implemented in any number of programming languages and a variety of different hardware, and that the style and format should not be construed as limiting, but rather a general template of the steps and procedures that would be consistent with code used to implement some embodiments of this disclosure.

At line 801, the algorithm may run a subroutine to initialize variables and prepare to match advertising events to advertising requests based on a request to match advertising events to advertising requests, which begins on line 805. For example, in some embodiments control circuitry 304 may copy instructions from non-transitory storage medium (e.g., storage device 308) into RAM or into the cache for processing circuitry 306 during the initialization stage. In some embodiments, the pseudocode of FIG. 8 may be executed periodically or automatically (e.g., as a process continuously running on a server) without user input to commence each iteration.

At line 805, control circuitry 304 may receive instances of advertising events from an advertising event queue. In some embodiments these instances may be retrieved from storage 308, a server, or content source 316.

At line 806, control circuitry 304 may iterate through the various instances of advertising events; if only a single instance is available, the loop will only execute once. This loop may be implemented in multiple fashions depending on the choice of hardware and software language used to implement the algorithm of FIG. 8; for example, this may be implemented as part of a “for” or “while” loop, in some programming languages. In some embodiments it may be convenient to store the instances of advertising events in a single class or encapsulated data structure that will perform the loop as part of an internal method.

At line 807, control circuitry 304 may query a database of advertising requests for entries matching predicted viewership information from the advertising event. Depending on how the database is implemented and how the predicted viewership information of the advertising event is stored, an intermittent step may be required to convert the predicted viewership information into a form consistent with the database. For example, the predicted viewership information may be encoded into a string or an integer using an appropriate hashing algorithm prior to being transmitted to the database by control circuitry 304 as part of a query. In some embodiments the predicted viewership information may be encoded as a primitive data structure, and control circuitry 304 may submit the predicted viewership information as a query to the database directly. After querying the database of advertising requests, control circuitry 304 may receive a set of database entries matching the predicted viewership information. In some embodiments control circuitry 304 may receive these entries in the form of a data-structure, a set of indices of the database, or a set of indices of another cross-referenced database.

At line 808, control circuitry 304 will determine if there are any database entries of advertising requests matching the predicted viewership information. In some embodiments control circuitry 304 may determine this by checking if the database returned an empty data structure or a NULL value in response to the query in line 807. If there are matching database entries the algorithm may proceed to line 809. If there were no matching database entries the algorithm may instead proceed to line 812.

At line 809, control circuitry 304 may retrieve one or more values of advertising requests from the database entries matching the predicted viewership. For example, if control circuitry 304 retrieves a list of indices after querying the database in line 807, in some embodiments control circuitry 304 may retrieve the database entries for advertising requests located at the received indices. In some embodiments the indices may point to a larger data structure contained within the database, and control circuitry 304 may retrieve the values of the viewership information for the advertising requests from within the data structure using appropriate accessor methods. In some embodiments control circuitry 304 may retrieve the values of the viewership information for the advertising requests and store them in a separate data structure locally (e.g., in storage 308) prior to proceeding further. After retrieving the values of the viewership information for the advertising requests the algorithm will proceed to line 810.

At line 810, control circuitry 304 will execute a subroutine to use the values of the predicted viewership information of the advertising requests and select an advertising request with a highest retrieval index using control circuitry. As referred to herein, the term “retrieval index” should be understood to mean a measure of a number of times that an advertising request has been retrieved, but unmatched to an advertising event. In some embodiments, control circuitry may employ another metric, to select an advertising request, as discussed above in reference to step 712 of FIG. 7. Afterwards, the algorithm may proceed to line 815.

At line 811, control circuitry 304 may determine if there are any database entries similar to the predicted viewership information of the advertising event. For example, the predicted viewership information of the advertising event may be represented by an object of a class. Control circuitry 304 may call a function to perform a fuzzy comparison (e.g., a comparison to identify similar objects of the class) by comparing specific fields of the class or by performing approximate string matching on data related to the predicted viewership information of the advertising event. If database entries similar to the predicted viewership information of the advertising event are found by control circuitry 304 then the algorithm proceeds to line 812. If control circuitry 304 does not find matching entries (e.g., a query to the database returns a NULL value), the algorithm proceeds to line 812.

At line 812, control circuitry 304 will execute a subroutine to use the values of the viewership information of the similar advertising requests and select an advertising request with a highest retrieval index using control circuitry. In some embodiments, control circuitry may employ another metric to select an advertising request, as discussed above in reference to step 716 of FIG. 7. Afterwards, the algorithm may proceed to line 815.

At line 813, control circuitry 304 will have determined that there were no database entries matching the predicted viewership information of the advertising event. In this case, the algorithm will proceed to line 814.

At line 814, control circuitry 304 will execute a subroutine to return an error using control circuitry if neither of the conditions at lines 808 or 811 are satisfied.

At line 815, control circuitry 304 will execute a subroutine to update matches of advertising events with advertising requests using control circuitry. For example, at a subsequent time after the initial matching, several of the advertisement events may have updated predicted viewership information that may be better matched. Afterwards, the algorithm may proceed to the termination subroutine at line 817.

At line 817, control circuitry 304 may execute a termination subroutine after the algorithm has performed its function and all instances of advertising events have been processed and checked against the database. For example, in some embodiments control circuitry 304 may destruct variables, perform garbage collection, free memory or clear the cache of processing circuitry 306.

It will be evident to one skilled in the art that the algorithm described by the pseudocode in FIG. 8 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments the code may be re-written so control circuitry 304 is instructed to evaluate multiple instances of advertising events and submit multiple database queries simultaneously using a plurality of processors or processor threads. It is also understood that although we may describe control circuitry 304 interacting with a single database, this is only a single embodiment described for illustrative purposes, and the algorithm of FIG. 8. may be implement using multiple independent or cross-referenced databases.

For example, a database stored locally (e.g., on storage 308) may index or cross-reference a database stored remotely (e.g., media guidance data source 418), which may be accessible through any number of communication channels (e.g., communications network 414). In some embodiments, this may allow control circuitry 304 to utilize a look-up table or database front-end efficiently stored on a small local drive to access a larger database stored on a remote server on demand.

Although the flowcharts of FIG. 5 and FIG. 7 have been illustrated as single iterations, it should be understood that the processes described in FIG. 5 and FIG. 7, and the corresponding pseudocode describing the algorithms illustrated by the flowcharts, may be implemented in processes that are running continuously and/or automatically. For example, the process 500 of FIG. 5 may be run periodically during a day to update predicted viewership information for advertising events in the advertising event queue. As discussed below, as a current time progresses, predicted viewership information for an advertising event might change as the amount of historical viewership information increases. Likewise, the process 700 of FIG. 7 may be run periodically to update the linking of advertising requests to advertising events in order to update the matching of advertising requests in view of updated viewership information.

Prediction of user viewership is essential for the planning of advertising campaigns. The prediction is important to advertisers, whose objective is to display advertisements before relevant target audiences. The prediction is important to content providers as well, so that they can best utilize a fixed number of advertising events to display advertisements to targeted audiences. For example, during a scheduled broadcast of a program, there may be a fixed number of commercial advertisement breaks. In order to efficiently reach a desired TRP, a content provider may display an advertisement in a minimum number of advertising events so that more advertising campaigns can be executed simultaneously.

ANNs and SVMs are two techniques that may be used to predict viewership information (e.g., Nielsen ratings) based on historical viewership information (e.g., Nielsen ratings recorded across six weeks). ANNs have been demonstrated to be accurate in predictions over shorter time horizons (e.g., 1-2 week time horizons), as compared to SVMs, which have been demonstrated to be accurate in predictions over longer time horizons (e.g., several month intervals). Experimental results demonstrating these findings are described further below.

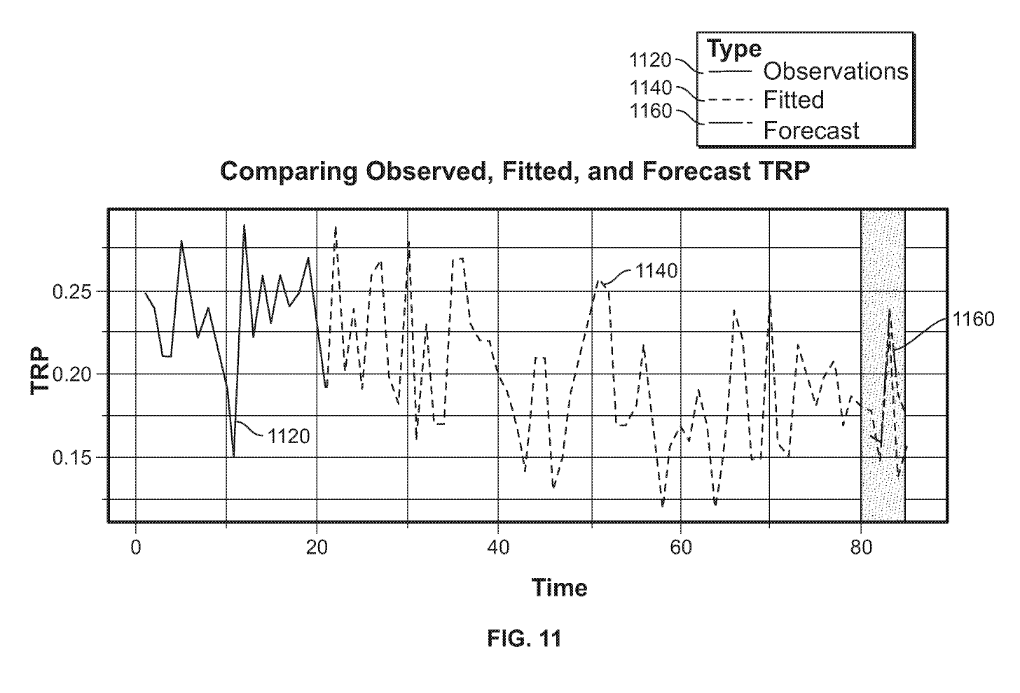

FIG. 9 illustrates a diagram of an ANN in accordance with some embodiments of the present disclosure. The ANN may be a feed forward network that includes three layers: an input layer 910, a hidden layer 940, and an output layer 960. In some embodiments, the ANN may include feedback between nodes of the input layer, hidden layer, and output layer. Although only one hidden layer has been illustrated in FIG. 9, it should be understood that more than one hidden layer may be used in some embodiments.

The ANN may include a set of inputs 905 for the input layer 910. The nodes of adjacent layers may be connected across the layers by a set of weights. For example, each of the nodes in input layer 910 maybe connected to nodes in hidden layer 940 by a set of weights 930. For example, each of the nodes in hidden layer 940 may be connected to nodes in output layer 960 by a set of weights 950. The number of nodes at the output layer may be 1. The output from the output layer may represent a prediction as a set of ratings information (e.g., demographic age group, and information about a media content such as genre). Control circuitry may train a separate ANN per time slot or media asset for prediction. For example, if there are two time slots at which ratings parameters are to be predicted, control circuitry may train two ANNs, one for each time slot. The number of nodes at the input layer may be equal to the number of lagged values used in a time series to predict the output. For example, if 6 sets of lagged values are used, then there may be 6 nodes at the input layer. The number of nodes at the hidden layer may be set as the number of lagged values+1, divided by 2, rounded up. For example, if there are 7 lagged values, then the number of nodes would be (7+1)/2, which is equal to 4 nodes. For example, if there are 10 lagged values, the number of nodes would be (10+1)/2, which when rounded up is equal to 6. The number of nodes at the hidden layer may also be set to a number between a number of nodes in the input layer and a number of nodes in the output layer. Although FIG. 9 illustrates pairwise connections between nearest nodes, it should be understood that any of the nodes in adjacent layers may be connected through a weighting.

The ANN may be described by the following equation.

yₜ=f(Σₙ₌₁^{N}(yₜ₋ₙ),W)+εₜ (EQ. 1)

The value yₜ represents the predicted value at time t. The value N represents the number of lagged values used in the prediction of yₜ. The value W represents a matrix of weights that are applied across the nodes within an artificial neural network, and εₜ represents an error term. EQ. 1 represents an aggregate of the operations that are performed within the ANN to compute the output yₜ from the input values {yₜ₋₁, . . . , y_{t-N}}. At each node of the artificial neural network, output values are computed based on linear combinations of the input values scaled by corresponding weights. For example, the output of node I₁ may be the input yₜ₋₁ multiplied by the weight W_{I1}. For example, the output of node H1 may be the inputs I₁ and I₂ multiplied by their respective weights. The output O of output layer 960, may be the linear combination of all inputs and corresponding weights (Σᵢ₌₁^{K}W_{Hi,O}*Hᵢ).

The ANN may be trained to predict data based on a series of past viewership information. For example, the ANN may be provided with several series of N+1 ratings measurements, and trained to reduce the output error of the predicted N+1^{th} rating, based on the prior N ratings. During this training process, the weights connecting nodes within the ANN are successively modified in order to reduce the training error.

Several experiments to demonstrate the improvement in accuracy of using ANNs to predict viewership information over conventional approaches such as time series averaging are described in further detail below. The experiments operated on Rovi 2.0 metadata and Nielsen TRP ratings collected over a 13-week period starting from Apr. 27, 2014. The target audience for Nielsen TRP ratings were live+same day for a demographic group of Adults age 18-49. The Broadcast networks evaluated were NBC, ABC, FOX, and CBS. Media guidance data was selected from the Rovi 2.0 metadata database.

Two types of features were explored: (type 1) program+hour+day features and (type 2) program+hour features. For example, in the type 1 features, TRPs for a final week was predicted based on a specific program (e.g., “Blacklist”), airing at a specific time (8:00 pm), and a specific day (e.g., Friday). Based on the prior historical viewership information measured for the specific program, at the specific time, and specific day, the viewership information for the next viewing of a program was predicted. For example, in the type 2 features, TRPs for a final week was predicted based on a specific program (e.g., “Blacklist”) airing during a week span (e.g., 13^{th} week) based on prior historical viewership information. The type 2 features provide a coarser level of analysis than the fine-grained analysis of type 1 features. An ANN was developed for each of the type 1 and type 2 features.

Two scenarios were evaluated: 1) using 12 week historical data to predict a 13^{th} week, and 2) using 6 week historical data to predict the 7^{th} week. Linear time series averages were used as controls. The program+hour+day features demonstrated an 88.13% predictive accuracy across all input data sets. The baseline models using linear time series (e.g., auto-regressive integrated moving average (ARIMA)) compute the mean of the historical data based on either time features only (day+hour) or type 1 features (program+day+hour) to predict the future (e.g., the 13^{th} week and the 7^{th} week).

Additional constraints were set on the input data. A minimum threshold number of recurrences were required in order for a prediction to be evaluated. For example, for the predictions based on a 6 week period, a minimum of 6 airings of a program might be required during the 6 week period in order to predict viewership information for the program during the 7^{th} week.

The number of lagged values selected for the experimental evaluation (e.g., number of prior data points per prediction such as 6 or 12) may be selected based on fitting an autoregressive time series model to the training data to select the best lagged value according to Akaike information criterion.

For each of the 12 week and 6 week scenarios, 4 models were evaluated. A first control model evaluated the predictive accuracy of computing the mean of the time series based on time schedule only (e.g., day+hour). For example, TRPs were predicted for a time slot without incorporating information about media assets that were displayed during the time slot. A second control model evaluated the predictive accuracy of computing the mean of the time series based on program, day, and hour features. For example, TRPs were predicted for a time slot based on prior viewership at that time, and based on information about a media asset that has previously been displayed.

A first experimental model evaluated the predictive accuracy of using an ANN parameterized with program+hour features. For example, TRPs were predicted for a time slot based on a program that was previously displayed during that time slot, without considering the day of the week in which the time slot appeared. A second experimental model evaluated the predictive accuracy of using an ANN parameterized with program+hour+day features. For example, TRPs were predicted for a time slot of a particular day based on a program that was previously displayed during that time slot.

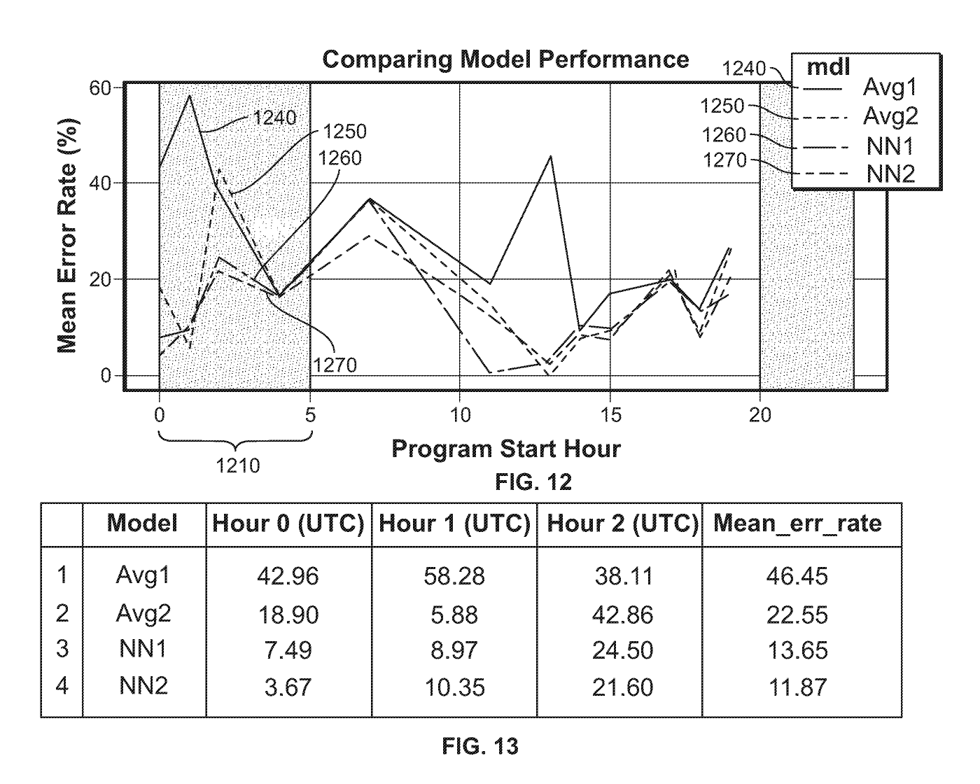

FIGS. 10-12 illustrate results of the experiments. FIG. 10 illustrates results of an evaluation using program+hour features. More specifically, FIG. 10 predicts TRPs for the program “General Hospital,” airing on the ABC Network, at 6:00 PM. FIG. 10 illustrates three graphs: observation 1020, fitted 1040 and forecast 1060. The observation graph 1020 represents the previously recorded viewership information. The fitted graph 1040 represents the model of trained data. The forecast 1060 represents the predicted result using the trained model. As observed from the graph, the fitted graph 1040 matches well to the observations 1020 of historical viewership information. Furthermore, the forecast graph 1060 matches well with those in the observations 1020.

FIG. 11 illustrates results of an evaluation using ANN trained using program and hour features only for predicting the Mad Money show at 7:00 A.M. More specifically FIG. 11 predicts TRPs for the program “Mad Money,” airing on the NBC Network at 7:00 AM on weekdays. FIG. 11 illustrates three graphs: observations 1120, fitted 1140 and forecast 1160. The observation graph 1120 represents the previously recorded viewership information. The forecast 1160 represents the predicted result based on the trained model. The fitted graph 1140 represents the model of trained data. As observed from the graph, the fitted graph 1140 matches well to the observations 1120 of historical viewership information. The forecast graph 1160 matches well with those in the observations 1120.

FIG. 12 illustrates a comparison of predictive accuracy, as measured by error rate, among the four models that were valuated. FIG. 12 illustrates a prime time region 1210. It includes four graphs for each of the four models: the first control (Avg1−time series average using program+hour) 1240; the second control (Avg2−time series average using program+hour+day) 1250; the first artificial neural network (NN1−ANN using program+hour) 1260; and the second artificial neural network (NN2−ANN using program+hour+day) 1270. During the prime time period the error rates of the two ANNs are substantially lower than the error rates of the two control models.

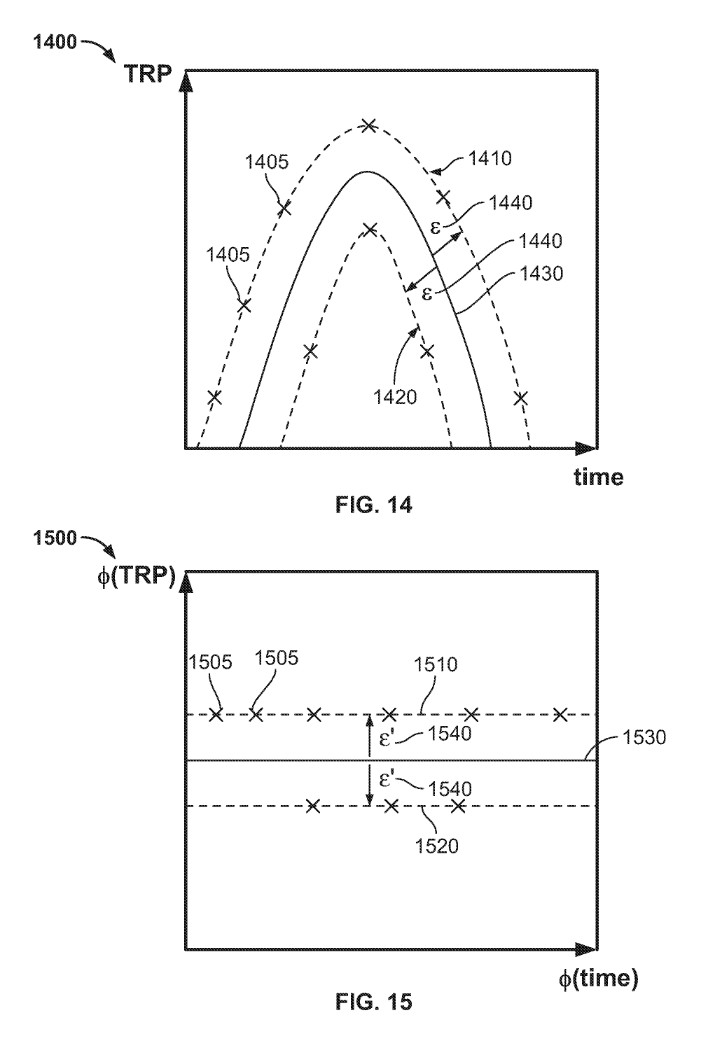

FIG. 13 illustrates a table of error rates across the four models for the prime time region 1210. As observed from the table, the mean error rate for the neural network models are lower than the mean error rate for the time series control models, indicating that using ANNs provides an improvement over conventional time series models.

Like ANNs, SVMs may be used to predict viewership information based on historical viewership information. SVMs may be used to predict a time series by performing regression on historical viewership information. An equation describing a support vector machine in accordance with some embodiments of the present disclosure is provided below:

$$min \frac{1}{m} {\sum }_{i = 1}^{m} Cost ( θ ( {x}^{i} , y ) ) + \frac{λ}{2 m} {\sum }_{j = 1}^{n} {θ}_{j}^{2} \qquad ( EQ . 2 )$$

In the function, m is the number of training data x; n is the number of features; λ is the regularization coefficient; y is the output. The first term represents the loss function and the second term represents regularization.

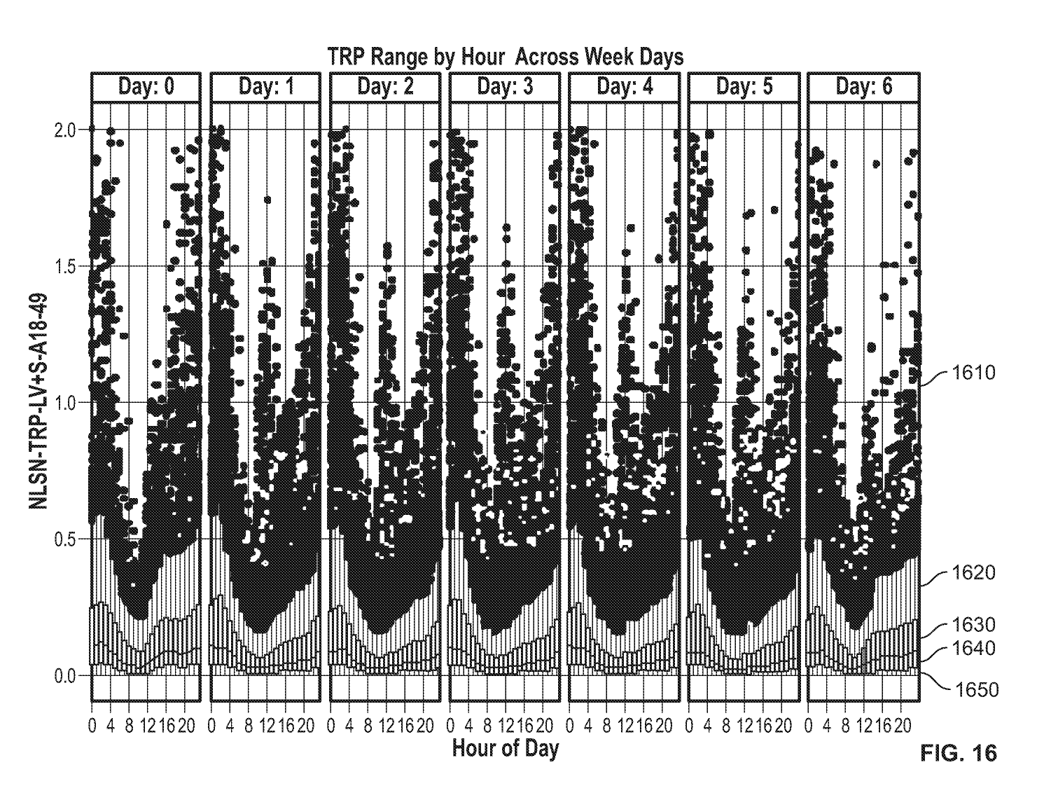

FIG. 14 illustrates an example of an implementation of a support vector machine in accordance with some embodiments of the present disclosure. FIG. 14 illustrates a time series 1405 of TRPs, where time is illustrated on the horizontal axis, and TRPs are illustrated on the vertical axis. The time series 1405 is non-linear, as indicated by a parabolic curve. Also illustrated in FIG. 14 are a hyperplane 1430 and support vectors 1410 and 1420 that span the hyperplane by an error margin E 1440.

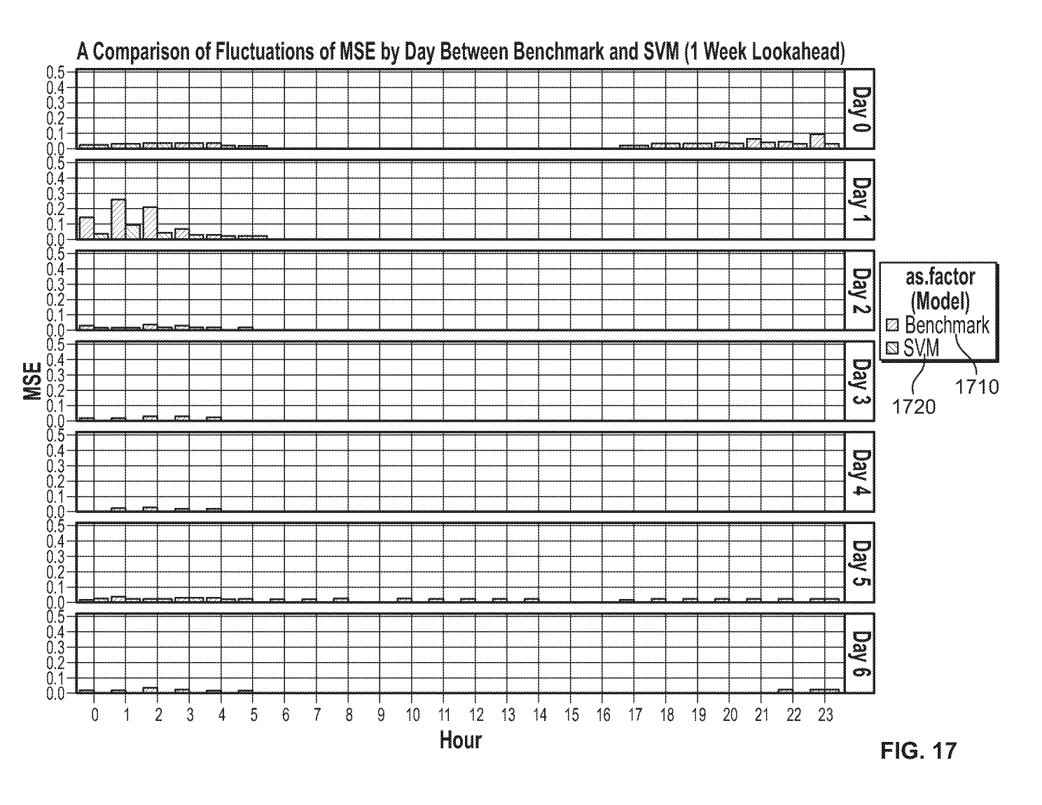

FIG. 15 illustrates an example of the non-linear time series of FIG. 14 transformed into a linear coordinate to facilitate mathematical computations of the support vectors. For example, the time series 1405 in FIG. 14 may be transformed into a new coordinate system by the function Φ( ), such that the new horizontal and vertical axes are Φ(time) and Φ(TRP) and that the transformed time series 1505 appears linear. FIG. 15 also illustrates a linear hyperplane 1530 and support vectors 1510 and 1520 that span the hyperplane by an error margin E 1540. The hyperplane may be represented by the following function.

W*Φ(time)+b±ε=0 (Eq. 3)

Because the hyperplane also represents a regression between a predicted Φ(TRP) and input time, the following function may be written to estimate a TRP at a future time.

W*Φ(time)−b±ε=Φ(TRP) (Eq. 4)

Several experiments to demonstrate the improvement in accuracy of SVMs to predict viewership information over conventional approaches such as time series averaging (e.g., ARIMA) have been performed. The experiments operated on 225,892 data records. The data included Nielson TRP rates collected over a 12 week period from Feb. 2, 2014 to Apr. 26, 2014. The target audience for Nielsen TRP rates were live+same day for a demographic group of Adults aged 18-49. Time based features, including day and time, were analyzed. Program information was not incorporated.

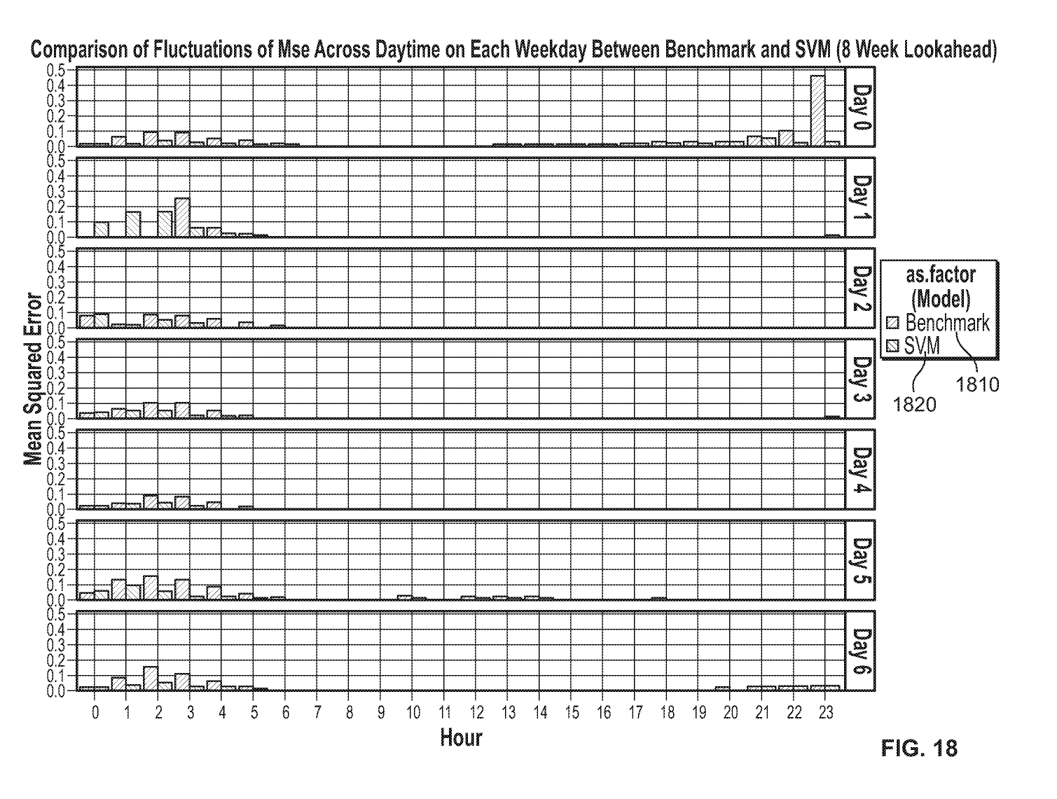

FIG. 16 illustrates the need for using an SVM to predict viewership. The black dots 1610 represent outliers that contribute to high variance in data. SVMs prevent over-fitting in at least two ways: using an Epsilon-Insensitive loss function, and including a regularization term in the objective function, as discussed above in reference to EQ. 2.

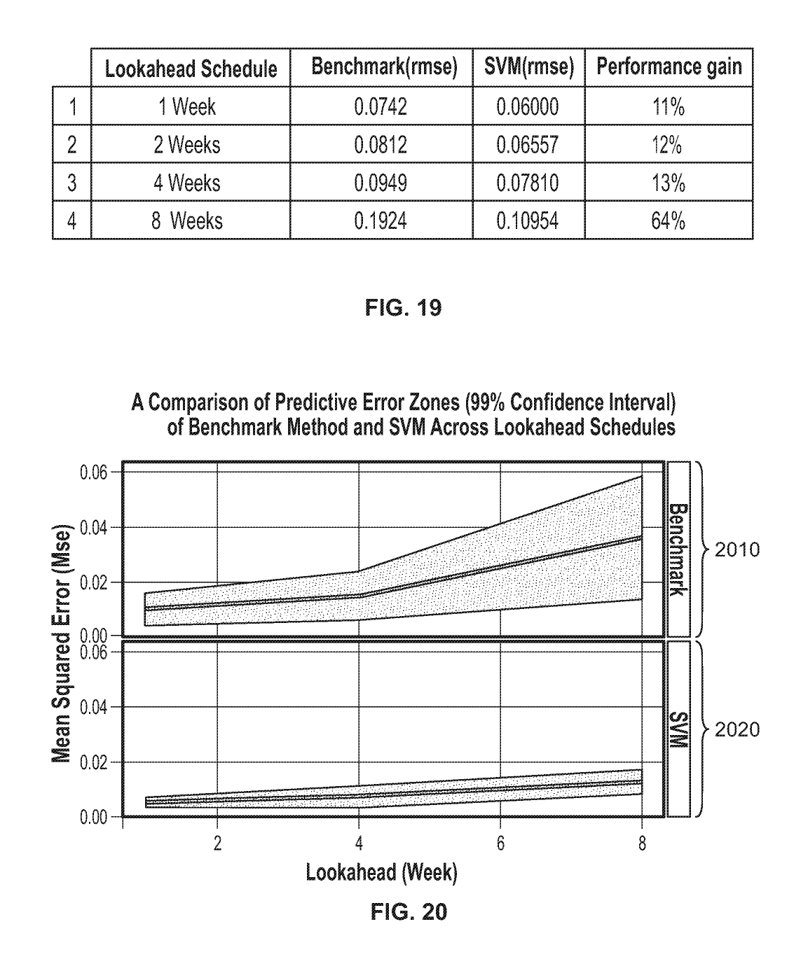

FIG. 17 illustrates a comparison of the error rate by each weekday between a benchmark test 1710 that uses time series averaging and an SVM based approach 1720. As observed from the graph, the error rate for the SVM is consistently lower than for the benchmark. The time series data in FIG. 17 is based on a 1 week prediction.

FIG. 18 illustrates a comparison of the error rate by each weekday between a benchmark test 1810 that uses time series averaging and an SVM based approach 1820. As observed from the graph, the error rate for the SVM is consistently lower than for the benchmark, demonstrating the improved accuracy of using the SVM.

The time series data in FIG. 18 is based on an 8 week lookahead. For example, a system may predict the average TRP ratings for the next 8 week period.

FIG. 19 illustrates a table of error rates across the benchmark and SVM approaches, examining a 1 week, 2 week, 4 week, and 8 week lookahead. The data illustrates that at the 8 week lookahead time period, the SVM approach outperforms the Benchmark approach by 64%.

FIG. 20 illustrates a graph of error bars for the prediction error rate of a benchmark approach 2010 as compared to an SVM approach 2020. As observed from FIG. 20, the prediction error rate of the benchmark approach continues to increase during the lookahead period, but the prediction error rate of the SVM approach remains fairly stable with minor increases

In some embodiments, the viewership prediction information may be selected from the ANN or SVM approach, depending on the time horizon. For example, as discussed above in reference to FIGS. 5-8, for viewership prediction information across a middle term (e.g., 2 month lookahead), SVMs may be more appropriate than ANNs, which may be more suitable for short-term lookahead of 1 week or less.

As discussed above, in reference to FIG. 5, a time of an advertising event (e.g., a future broadcast of an interstitial advertisement) may be compared with a threshold. If the time of the future broadcast occurs within a one week window, an ANN-based approach may be more accurate. If the time of the future broadcast exceeds the one week window, an ANN based approach may be less accurate than an SVM approach. Based on the comparison between the time of the advertising event and the threshold, the viewership prediction of the ANN may be used if the time of the event is within a short time horizon (e.g., 1 week), or the SVM may be used if the time of the advertising event is at a longer timer horizon (e.g., 1 month).

In some embodiments, control circuitry of a system may implement a hybrid approach to computing predictions of viewership information. For example, the control circuitry of a system may compute a weighted average of the viewership prediction information determined by an ANN approach and SVM approach. For example, control circuitry may determine that a percentage by which a time of an advertising event exceeds a first threshold (1 week from a current time), but is less than a second threshold (9 weeks from a current time). For example, if the time of an advertising event is 6 weeks from current time, the percent would be 6 weeks minus 1 week=5 weeks, divided by the interval of 8 weeks (9 weeks from current time minus 1 week from current time). Accordingly, the ratio would be 0.625. The viewership prediction information would then be weighted accordingly, 0.375 for the ANN based prediction, and 0.625 for the SVM based prediction. In some embodiments, control circuitry of a system may implement a hybrid approach that employs multiple machine learning techniques (e.g., ANN, SVM, fourier transforms, Bayesian linear regression, etc.). For example, each of the techniques or combinations thereof may be configured for predictions across a specified period in the future (e.g., 2-4 weeks, 4-6 weeks, etc.). Control circuitry may compare a specified time of an advertising event with one or more thresholds to determine an approach machine learning technique to employ.

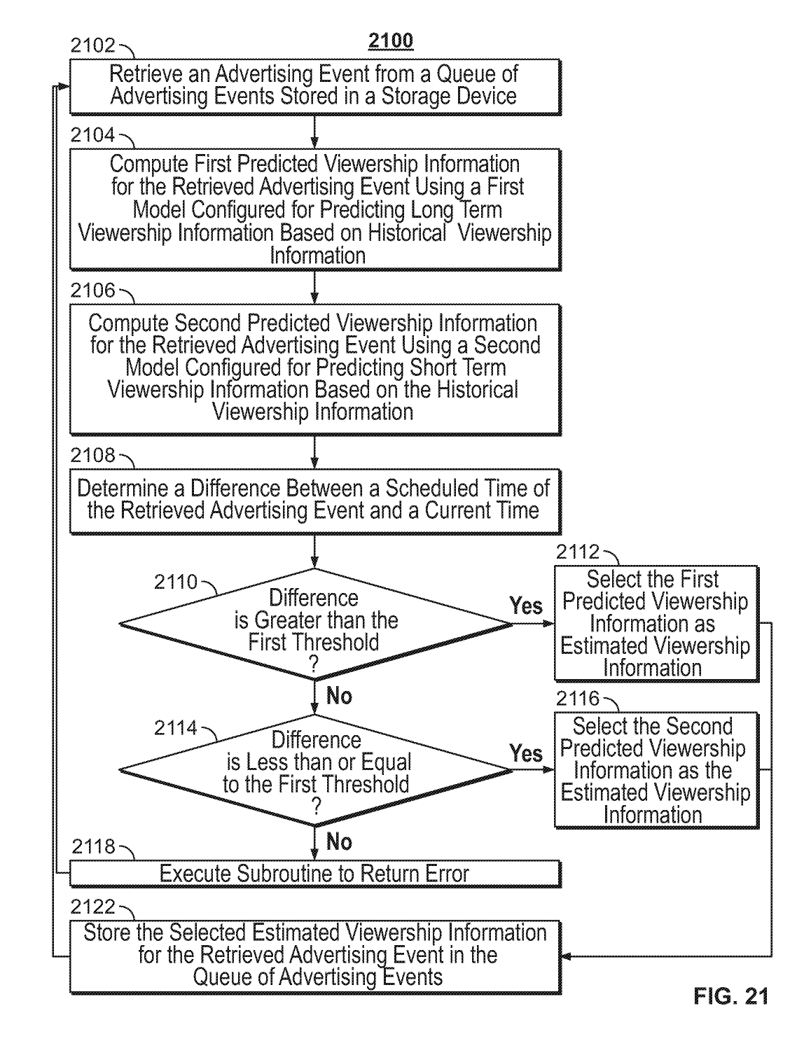

FIG. 21 is a flowchart of a process 2100 for predicting viewership information at a future time for an advertising event in accordance with some embodiments of the disclosure. It should be noted that process 2100, or any step thereof, could be performed on, or provided by, any other devices shown in FIGS. 3-4. For example, process 2100 may be executed by control circuitry 304 as instructed by a media guidance application implemented on user equipment 402, 404, or 406, in order to play back media. In addition, one or more steps of process 2100 may be incorporated into or combined with one or more steps of any other process or embodiment (e.g., process 500 and 700).

At step 2102, control circuitry retrieves an advertising event from a queue of advertising events stored in a storage device. For example, control circuitry (e.g., at a server) may retrieve an advertising event (e.g., for an interstitial advertisement schedule for one week in the future) from an advertising event queue.

At step 2104, control circuitry computes first predicted viewership information for the retrieved advertising event using a first model configured for predicting long-term viewership information based on historical viewership information. For example, control circuitry (e.g., at a server) may compute predicted viewership information (e.g., demographic information) for the advertising event at the scheduled time of display of the advertising event based on historical viewership information (e.g., demographic information and/or a program that was displayed at prior occurrences of a corresponding scheduled time slot). In some embodiments, the first model configured for long-term prediction may be a support vector machine, parameterized based on historical viewership information that includes viewership information for a period of longer than four weeks.

At step 2106, control circuitry computes second predicted viewership information for the retrieved advertising event using a second model configured for predicting short-term viewership information based on the historical viewership information. For example, control circuitry (e.g., at a server) may compute predicted viewership information (e.g., demographic information and information for a media asset displayed at or around the time of the advertising event) for the advertising event at the scheduled time of display of the advertising event based on historical viewership information (e.g., demographic information and/or a program that was displayed at prior occurrences of a corresponding scheduled time slot). In some embodiments, the second model configured for short-term prediction may be an artificial neural network.

At step 2108, control circuitry determines a difference between a scheduled time of the retrieved advertising event and a current time. For example, control circuitry may determine that a difference between the scheduled time and present time is a period of four weeks. It should be understood that the difference may be quantified in any suitable units of time such as second, hour, day, week, month, year, any other suitable unit of time or any combination thereof.

At step 2110, control circuitry determines whether the difference is greater than the first threshold. In response to determining that the difference is greater than the first threshold, control circuitry proceeds to step 2112. Otherwise control circuitry proceeds to step 2114. For example, the first threshold may be a period of four weeks. Control circuitry may determine that a difference between the specified time of the advertising event and the current time is a period of nine weeks, which is greater than the first threshold.

At step 2112, in response to determining that the difference is greater than the first threshold, control circuitry selects the first predicted viewership information as estimated viewership information. For example, control circuitry may select the predicted viewership information that was computed using the support vector machine based model configured for long-term predictions. Control circuitry then proceeds to step 2122.

At step 2114, control circuitry determines whether the difference is less than or equal to the first threshold. In response to determining that the difference is less than or equal to the first threshold, control circuitry proceeds to step 2116. Otherwise, control circuitry proceeds to step 2118. For example, the first threshold may be a period of four weeks. Control circuitry may determine that a difference between the specified time of the advertising event and the current time is a period of two weeks, which is less than the first threshold. In some embodiments, control circuitry may execute steps 2108, 2110, or 2114 before steps 2104 and 2106. For example, control circuitry may first determine a difference between a scheduled time of a retrieved advertising event and a current time, and compare the difference to a first threshold. Based on the comparison, control circuitry may compute a first predicted viewership information based on the first model configured for long-term prediction, if the difference is greater than the first threshold. Based on the comparison, control circuitry may compute a second predicted viewership information based on the second model configured for short-term prediction. Under this order of steps, control circuitry only performs the computation on demand. Under the order of steps illustrated in FIG. 21, steps 2104 and 2106 may run as background processes continuously computing predicted viewership information as updates.

At step 2116, control circuitry selects the second predicted viewership information as the estimated viewership information. For example, control circuitry may select the predicted viewership information that was computed using the artificial neural network based model configured for short-term predictions. Control circuitry then proceeds to step 2122.

At step 2118, control circuitry executes a subroutine to return error. For example, control circuitry may generate for display an error message. Control circuitry then proceeds to step 2102 to repeat the process.

At step 2122, control circuitry stores the selected estimated viewership information for the retrieved advertising event in the queue of advertising events. For example, control circuitry may update the predicted viewership information for the retrieved advertising event to include demographic information for a predicted audience and/or predicted information about a media asset that is generated at or around the specified time of display of the advertising event.

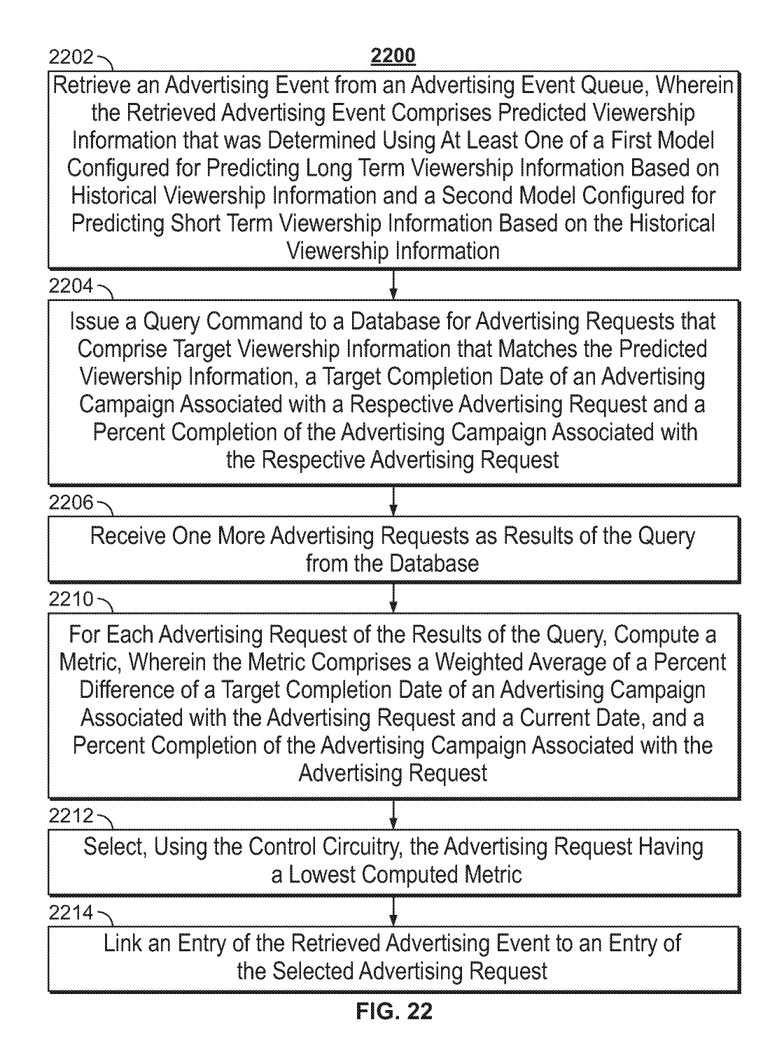

FIG. 22 is a flowchart of a process 2200 for matching advertising requests to advertising events based on predicted viewership information of the advertising events in accordance with some embodiments of the present disclosure. It should be noted that process 2200, or any step thereof, could be performed on, or provided by, any other devices shown in FIGS. 3-4. For example, process 2200 may be executed by control circuitry 304 as instructed by a media guidance application implemented on user equipment 402, 404, or 406, in order to play back media. In addition, one or more steps of process 2200 may be incorporated into or combined with one or more steps of any other process or embodiment (e.g., process 500, 700 and or 2100).

At step 2202, control circuitry retrieves an advertising event from an advertising event queue, where the retrieved advertising event includes predicted viewership information that was determined using at least one of a first model configured for predicting long-term viewership information based on historical viewership information and a second model configured for predicting short-term viewership information based on the historical viewership information. For example, control circuitry may retrieve an advertising event corresponding to an interstitial advertisement that is scheduled to be generated for display at a specified time that has predicted viewership information of a demographic of ages 10-19. For example, control circuitry may have determined the predicted viewership information using a first model (e.g., a support vector machine), configured for long-term predictions as discussed above in reference to step 2104 of FIG. 21. For example, control circuitry may have determined the predicted viewership information using a second model (e.g., an artificial neural network), configured for short-term predictions as discussed above in reference to step 2106 of FIG. 21.

At step 2204, control circuitry issues a query command to a database for advertising requests that includes target viewership information that matches the predicted viewership information, and that includes a target completion date of an advertising campaign associated with a respective advertising request and a percent completion of the advertising campaign associated with the respective advertising request. For example, control circuitry may issue a query command to a database of advertising requests for advertising requests that have target viewership information that matches the predicted viewership information of the retrieved advertising event. For example, control circuitry may issue a query for advertising requests that match predicted viewership information for a demographic of viewers ages 10-19. The advertising requests may include a target completion date of an associated advertising campaign (e.g., an advertising campaign for a video game).

At step 2206, control circuitry receives one or more advertising requests as results of the query from the database. For example, control circuitry may receive a first advertising request corresponding to a first advertising campaign for a video game targeted towards a demographic of ages 10-18, and a second advertising request corresponding to a second advertising campaign for a movie targeted towards a demographic of ages 10-18.

At step 2210, control circuitry computes a metric for each advertising request of the results of the query, where the metric includes a weighted average of a percent difference of a target completion date of an advertising campaign associated with the advertising request and a current date, and a percent completion of the advertising campaign associated with the advertising request. For example, the first advertising request result may correspond to the video game targeted towards the demographic of ages 10-18, and may have a target completion date of two weeks from a current time, and a percent completion of the advertising campaign of 40%. If equal weights are applied to each parameter, control circuitry may compute a metric of 0.5*2+0.5*40 for a metric of 21. For example, the second advertising request result for the movie targeted towards a demographic of ages 10-18 may have a target completion date of one week from a current date and a percent completion of an advertising campaign of 10%. If equal weights are applied to each parameter, control circuitry may compute a metric of 0.5*1+0.5*10 for a metric of 6.

At step 2212, control circuitry selects, using the control circuitry, the advertising request having a lowest computed metric. For example, control circuitry may select the second advertising request having the lowest metric of 6 compared to the first advertising request having a metric of 21.

At step 2214, control circuitry links an entry of the retrieved advertising event to an entry of the selected advertising request. For example, control circuitry may update an entry of the advertising event in the advertising event queue to include a unique identifier of the selected second advertising event. Control circuitry may vice versa update an entry of the second advertising request in the database for advertising requests to include a unique identifier of the retrieved advertising request.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiments in a suitable manner, done in different orders, or done in parallel. Furthermore, it should be noted that while a first step may be based on and/or in response to a second step, such a relationship does not preclude additional steps occurring between the first and second steps. In addition, the systems and methods described herein may be performed in real time. It should also be noted that although the systems and methods have been described above in the context of artificial neural networks and support vector machines, the systems and/or methods described above may be applied to, or used in accordance with, other systems and/or methods and/or machine learning techniques.

1. A method for matching advertising requests to advertising events, comprising:
retrieving an advertising event from an advertising event queue, wherein the retrieved advertising event comprises predicted viewership information that was determined using at least one of a first model configured for predicting long-term viewership information based on historical viewership information and a second model configured for predicting short-term viewership information based on the historical viewership information;
issuing a query command to a database for advertising requests that comprise target viewership information that matches the predicted viewership information, a target completion date of an advertising campaign associated with a respective advertising request and a percent completion of the advertising campaign associated with the respective advertising request;
receiving one or more advertising requests as results of the query from the database;
for each advertising request of the results of the query, computing a metric, wherein the metric comprises a weighted average of a percent difference of a target completion date of an advertising campaign associated with the advertising request and a current date, and a percent completion of the advertising campaign associated with the advertising request;
selecting the advertising request having a lowest computed metric; and
linking an entry of the retrieved advertising event to an entry of the selected advertising request.

2. The method of claim 1, further comprising:
determining that the results of the query include no results;
adjusting parameters of the predicted viewership information of the retrieved advertising event;
issuing a second query command to the database for advertising requests that include target viewership information that is similar to the adjusted parameters of the predicted viewership information;
for each advertising request of the results of the second query, computing a metric as a weighted average of a percent difference of a target completion date of an advertising campaign associated with the respective advertising request corresponding to the second query and a current date, and a percent completion of the advertising campaign associated with the respective advertising request corresponding to the second query;
selecting the advertising request of the second query results having a lowest computed metric; and
linking an entry of the retrieved advertising event to an entry of the selected advertising request.

3. The method of claim 1, wherein the linking the entry of the retrieved advertising event to the entry of the selected advertising request further comprises:
updating an entry for the selected advertising request in the database to include an identifier of the linked advertising event; and
updating an entry for the advertising event in the advertising event queue to include an identifier of the linked advertising request.

4. The method of claim 1, wherein the predicted viewership information comprises demographic information, and a percentage of predicted viewers from an audience corresponding to the demographic group.

5. The method of claim 1, wherein the historical viewership information comprises identifier information about a media asset, demographic information, a day of week that the media asset was generated for display, and a time of day that the media asset was generated for display.

6. The method of claim 1, wherein the first model is a support vector machine configured for predicting long-term viewership information.

7. The method of claim 6, further comprising:
selecting a subset of the historical viewership information as training time series data;
selecting, as a target output, an entry from the historical viewership information that corresponds to a viewing activity that occurred after all viewing activities corresponding to the subset of the historical viewership information selected as the training time series data;
applying a transformation function to the selected subset of training time series data to generate a transformed set of training time series data and to the target output to generate a transformed target output; and
inputting the transformed set of training time series data into the support vector machine.

8. The method of claim 1, wherein the second model is an artificial neural network configured for predicting short-term viewership information.

9. The method of claim 8, further comprising:
implementing the artificial neural network as a feed-forward artificial neural network comprising an output layer, a hidden layer, and an input layer, wherein the output layer comprises a node, and the input layer comprises a number of input nodes equal to a number of lagged values of a training time series data.

10. The method of claim 8, further comprising:
computing a number of hidden nodes as the number of the lagged values of the training time series data incremented by one, and divided by two;
setting a number of hidden nodes in the hidden layer to the computed number of hidden nodes.

11. A system for matching advertising requests to advertising events, comprising:
a storage device configured to store an advertising queue; and
control circuitry configured to:
retrieve an advertising event from an advertising event queue, wherein the retrieved advertising event comprises predicted viewership information that was determined using at least one of a first model configured for predicting long-term viewership information based on historical viewership information and a second model configured for predicting short-term viewership information based on the historical viewership information;
issue a query command to a database for advertising requests that comprise target viewership information that matches the predicted viewership information, a target completion date of an advertising campaign associated with a respective advertising request and a percent completion of the advertising campaign associated with the respective advertising request;
receive one more advertising requests as results of the query from the database;
for each advertising request of the results of the query, compute a metric, wherein the metric comprises a weighted average of a percent difference of a target completion date of an advertising campaign associated with the advertising request and a current date, and a percent completion of the advertising campaign associated with the advertising request;
select the advertising request having a lowest computed metric; and
link an entry of the retrieved advertising event to an entry of the selected advertising request.

12. The system of claim 11, wherein the control circuitry is further configured to:
determine that the results of the query include no results;
adjust parameters of the predicted viewership information of the retrieved advertising event;
issue a second query command to the database for advertising requests that include target viewership information that is similar to the adjusted parameters of the predicted viewership information;
for each advertising request of the results of the second query, compute a metric as a weighted average of a percent difference of a target completion date of an advertising campaign associated with the respective advertising request corresponding to the second query and a current date, and a percent completion of the advertising campaign associated with the respective advertising request corresponding to the second query;
select the advertising request of the second query results having a lowest computed metric; and
link an entry of the retrieved advertising event to an entry of the selected advertising request.

13. The system of claim 12, wherein the control circuitry is further configured to:
update an entry for the selected advertising request in the database to include an identifier of the linked advertising event; and
update an entry for the advertising event in the advertising event queue to include an identifier of the linked advertising request.

14. The system of claim 11, wherein the predicted viewership information comprises demographic information, and a percentage of predicted viewers from an audience corresponding to the demographic group.

15. The system of claim 11, wherein the historical viewership information comprises identifier information about a media asset, demographic information, a day of week that the media asset was generated for display, and a time of day that the media asset was generated for display.

16. The system of claim 11, wherein the first model is a support vector machine configured for predicting long-term viewership information.

17. The system of claim 16, wherein the control circuitry is further configured to:
select a subset of the historical viewership information as training time series data;
select, as a target output, an entry from the historical viewership information that corresponds to a viewing activity that occurred after all viewing activities corresponding to the subset of the historical viewership information selected as the training time series data;
apply a transformation function to the selected subset of training time series data to generate a transformed set of training time series data and to the target output to generate a transformed target output; and
input the transformed set of training time series data into the support vector machine.

18. The system of claim 11, wherein the second model is an artificial neural network configured for predicting short-term viewership information.

19. The system of claim 18, wherein the control circuitry is further configured to:
implement the artificial neural network as a feed-forward artificial neural network comprising an output layer, a hidden layer, and an input layer, wherein the output layer comprises a node, and the input layer comprises a number of input nodes equal to a number of lagged values of a training time series data.

20. The system of claim 18, wherein the control circuitry is further configured to:
compute a number of hidden nodes as the number of the lagged values of the training time series data incremented by one, and divided by two;
set a number of hidden nodes in the hidden layer to the computed number of hidden nodes.

21-50. (canceled)
